(19) United States
(12) Patent Application Publication
(10) Pub. No.: US 2006/0116966 A1
(43) Pub. Date: Jun. 1, 2006

(54) Methods and systems for verifying protectable content

(76) Inventors: Palle M. Pedersen, Boston, MA (US); Douglas A. Levin, Boston, MA (US)

Correspondence Address: GOODWIN PROCTER LLP;PATENT ADMINISTRATOR, EXCHANGE PLACE, BOSTON, MA, 02109-2881, US

(21) Appl. No.: 11/326,806

(22) Filed: Jan. 6, 2006

Related U.S. Application Data
(63) Continuation-in-part of application No. 10/728,173, filed on Dec. 4, 2003.
(63) Continuation-in-part of application No. 10/728,174, filed on Dec. 4, 2003.

(51) Int. Cl. G06Q 99/00

(52) U.S. Cl. 705/59

(57) ABSTRACT

A license for a first component of a protectable content is verified and a license for a second component of the protectable content is verified. A license for the protectable content is then verified based at least in part on the verification of the license for the first component and the verification of the license for the second component.

### CROSS-REFERENCE TO RELATED APPLICATIONS

This application is a continuation-in-part of co-pending U.S. patent application Ser. No. 10/728,173, entitled “AUTHENTICATING LICENSES FOR LEGALLY-PROTECTABLE CONTENT BASED ON LICENSE PROFILES AND CONTENT IDENTIFIERS,” which was filed on Dec. 4, 2003, and is a continuation-in-part of U.S. patent application Ser. No. 10/728,174, entitled “RESOLVING LICENSE DEPENDENCIES FOR AGGREGATIONS OF LEGALLY-PROTECTABLE CONTENT” which was filed on Dec. 4, 2003.

### TECHNICAL FIELD

The invention generally relates to the verification of protectable content. More particularly, the invention relates to methods and systems for verifying a license for the protectable content based at least in part on verifications of the licenses for the protectable content's components.

### BACKGROUND

Digital documents, files, and media can all be easily manipulated. For example, a third-party's source code can easily be downloaded over the Internet, or otherwise copied, and added to an existing software product. Whether such copying is permitted may not be immediately apparent to a user of the software product; however, it can prove to be problematic, for example if it is later discovered by the third party having rights in the copied software code. For example, in the context of software development, there is a continued increase in the availability of “open source” software, in which software products are distributed in source code and executable form over the Internet without charge, in a manner that makes it easy for a developer to download code and integrate it into other software products.

Typically, software products or other protectable content are distributed together with, or with reference to, one or more licenses said to govern the use and/or distribution of the software. For example, a software product may be downloaded from a content provider's website together with one or more licenses. These licenses typically specify terms to be followed as a condition of use or distribution of the software product. A developer typically will consider carefully the licensing terms of software products before including those products in his own software products.

In some cases, the individual downloading the software product and the licenses may have personal knowledge of the licenses that apply to that product. Even in such cases, however, the individual often will not know if additional software code and/or other protectable content has been added, either intentionally or by accident, to the software product and, if so, will not know whether the use and/or distribution of that added content is in fact governed by the licenses indicated in the product code or documentation. At present, it is difficult for a developer to know what licenses are in fact applicable to code with a high degree of certainty.

### SUMMARY OF THE INVENTION

The present invention relates to methods and systems that allow a content user to determine with a high degree of certainty what license and terms are applicable to applicable content, for example, but not limited to, a software product. The systems and methods described here allow an entity to review content (e.g., software code) and generate information about the reviewed content, including a “manifest” of what components, (e.g., third-party software products) are included in the code, and the licenses applicable to those components. The generated information also can include a signature on the reviewed code, such that a user or developer can determine that she has the same code that was previously verified.

A user or content developer that later wants to make use of the protectable content can review the generated information (e.g., the manifest and the code) and use that information to verify the protectable content, the components of the protectable content and the applicable licensing terms. In the illustrative example of a software developer who is considering use of open source software product, the developer can download an open source software product, obtain the generated information, and use the generated information to verify the components of the downloaded software, verify the licenses that are applicable to the components of the downloaded software, and verify the license of the entire open source software product. By using the generated information to confirm that the code downloaded includes only the previously verified code, and that the licenses allow use of the code in the desired manner, the developer will be able to use the open source software with a much higher degree of confidence in its technical and legal integrity.

In general, in one aspect, a protectable content and a set of licenses governing the use and/or distribution of the protectable content are received at a computing device. In such an embodiment, to facilitate the verification of the protectable content, the computing device first decomposes the protectable content into components, for example in a hierarchical fashion. One or more of a variety of techniques are then used to identify each component. Having identified a component, the license received at the computing device that is stated to govern the use and/or distribution of that component is then verified to determine whether it in fact does so. Optionally, after each component of the protectable content is verified to be validly covered by one of the received licenses, a license for the protectable content itself is verified. This verification of the license for the protectable content itself is based at least in part on the verifications of the content and of the licenses for the components of the protectable content.

In one aspect, an embodiment of the invention features a method for verifying protectable content. In accordance with the method, a license for a first component of the protectable content is verified, a license for a second component of the protectable content is verified. Optionally, a license for the protectable content itself is verified, where the verification of the license for the combined first and second protectable content itself is based at least in part on the verification of the license for the first component and the verification of the license for the second component. It should be understood that there can be any number of components (e.g., a third, fourth, fifth, etc.) although for simplicity only a first and second are discussed.

Various embodiments of this aspect of the invention include the following features. The verification of the license for the first component may include determining the identity of the first component, determining a stated profile for the first component, and comparing the stated profile against a stored profile associated with the identity of the first component. In such a case, the stated profile may include an origin of the first component and/or license terms for the first component, and the stored profile may also include an origin of the first component and/or license terms for the first component. Similarly, the verification of the license for the second component may include determining the identity of the second component, determining a stated profile for the second component, and comparing the stated profile against a stored profile associated with the identity of the second component. In this latter case, the stated profile may include an origin of the second component and/or license terms for the second component, and the stored profile may also include an origin of the second component and/or-license terms for the second component.

Verification of the licenses can also include verifying a previously generated signature of the first component and/or a signature of the second component. For example, a signature, such as an RSA-based signature or an MD5 checksum, can be verified to determine that a component is in fact the component to which a particular license is applicable. Likewise, a signature, such as an RSA-based signature or an MD5 checksum, on multiple components, or even on the entire protectable content, can be used to verify the applicable license.

In one embodiment, the license for combined first and second protectable content includes the license for the first component of the protectable content and the license for the second component of the protectable content. Alternatively, in another embodiment, the license for the combined protectable content includes the union of the most restrictive aspects of the license for the first component and the most restrictive aspects of the license for the second component, if allowed by both licenses.

For its part, the protectable content may include one or more of a source code file, an object code file, a multimedia presentation, a video segment, an audio segment, a textual representation, a work of art, a visual representation, a technological know-how, a business know-how, or a contract right, or some combination. Thus, protectable content may be, as non-limiting examples, a number of source code files only, one source code file and some object code files, or a multimedia game program that includes source code files, object code files, video and audio components, and still graphics.

For example, in one embodiment, a license and/or content may be verified by referring to a certificate in which an entity (e.g., person, group, organization, or business) has certified that protectable content having a particular signature is covered by a license. For example, an entity may make available a certificate (e.g., certification information) listing the components of a combined protectable content (e.g., with a first component, second component), a signature associated with each component or group of components, and a license associated with each component or group of components. The verifying is then performed by determining that the signatures of the content components match the signatures found in the certificate.

Prior to using such a certificate, the entity can generate the certificate by manual and/or automatic (e.g., computer-based) verification of the protectable content. The entity can generate a signature and license information for each content based on the determination that the content is intact and that the identified license is applicable. For example, such verification can include a computer-based review or comparison of the content (or information derived from the content) against a library of other content (or information derived from other content). As another example, such verification can include manual inspection of the modification history of the content, and the modifications e.g., since the last time such a review was performed.

In yet another embodiment, the method further includes decomposing the protectable content into first and second components of the protectable content. The method may also further include digitally signing the protectable content after the license for the first component is verified to be valid and the license for the second component is verified to be valid. Alternatively, in still another embodiment, the protectable content may be digitally signed after the license for the first component is verified to be valid, the license for the second component is verified to be valid, and the license for the protectable content itself is verified to be valid.

In general, in another aspect, the invention relates to a method for verifying protectable content. The method includes verifying a first component of the protectable content, verifying a second component of the protectable content, and verifying the protectable content based at least in part on the verification of the first component and the second component. It should be understood that there can be additional verifications. For some content, verifying components can require verification of subcomponents, etc. It also should be understood that additional components are contemplated, and that the first and second components described can be two, three, four or more. The verifications can be performed, for example, for the benefit of others, so that other people or entities can be confident that the content has been verified, or it can be performed by a potential user or distributor of the content, so that the user or distributor can be assured of the origin of the content.

Various embodiments include a variety of features. In one embodiment, the verification of the first component includes, for example, such steps as determining the identity of the first component, determining stated information for the first component, and comparing the stated information against a stored profile associated with the identity of the first component. The stated information could include, for example, a stated origin of the first component. The stored profile could identify an origin of the first component. The stated information could include license terms for the first component. Likewise, the stored profile could include license terms for the first component.

The stored profile could include a list of the elements of the protectable content, for example, a table of contents. Such a list, for example, could be hierarchical and/or can include elements of the first component and the second component.

For its part, the verification of the second component could include, for example, determining the identity of the second component, determining stated information for the second component, and comparing the stated information against a stored profile associated with the identity of the second component. Again, the stated information can include an origin of the second component, and the stored profile can include an origin of the second component. Likewise, the stated information could include license terms for the second component, and the stored profile could include license terms for the second component. The method also may include decomposing the protectable content into the first and second components, and verifying the components separately. For example, if the components each have subcomponents, this may be helpful.

The method can include digitally signing the protectable content after the first component is verified and the second component is verified. The method can include digitally signing each of the first component, the second component, and any additional components, individually, or in some combination. The components can be signed after the first component, second component, or other components are verified, or after the protectable content is verified. For example, if an entity is verifying protectable content for the benefit of others, that entity can sign the components of the protectable content that have been verified.

Likewise, if a user or distributor of the protectable content is verifying the protectable content such user or distributor may wish to verify digital signatures associated with the components of the protectable content and/or the entire protectable content. Verifying the digital signature of the protectable content can take place as part of the verification of the first component, second component, or other components, or can be after the components are otherwise verified.

In general, in another aspect, the invention relates to a computer readable medium comprising a data structure for use in verifying protectable content. The protectable content can include, for example, computer source code. The data structure can include a hierarchical list of elements of protectable content. The list can include, for each component of the protectable content, an identification of such component of the protectable content, a list of the elements of such component of protectable content, stated information for such component of protectable content, and a digital signature on the component of the protectable content. As above, the stated information can include license terms for the component. The data structure can be implemented, for example, in a self-describing computer language such as XML. A user or distributor of the protectable content, for example, can use such a data structure to verify protectable content.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 schematically illustrates an exemplary collaboration architecture employing aspects of the disclosed technology that can be used to identify one or more aggregated licenses for an aggregated content that is based on a combination of individually-licensed, protectable content elements;

FIG. 2 illustrates an exemplary methodology that may be performed by one or more software processes executing within the collaboration architecture of FIG. 1 to identify an aggregated license for an aggregated content of interest;

FIGS. 3A and 3B schematically illustrate an exemplary licensing authority architecture employing aspects of the disclosed technology that can be used to authenticate one or more licenses associated with protectable-content elements;

FIG. 4 illustrates an exemplary methodology that may be performed by one or more software processes executing within the licensing authority architecture of FIGS. 3A and 3B to authenticate licenses associated with protectable-content elements of interest;

FIG. 5 is a block diagram of an illustrative embodiment of a system for verifying protectable content in accordance with the invention;

FIG. 6 is a flow diagram of an illustrative embodiment of a method for verifying protectable content in accordance with the invention; and

FIG. 7 illustrates one embodiment of a hierarchical structure for a protectable content in accordance with the invention.

FIG. 8 illustrates an exemplary embodiment of the invention;

FIG. 9 shows an exemplary content report for protectable content.

### DETAILED DESCRIPTION

### DEFINITIONS

For the purposes of this disclosure, the following terms are defined as follows:

“aggregated content” (also referred to herein as an “aggregated-content element”) refers to a collection and/or combination of at least some aspects of two or more protectable-content elements that cooperate to perform one or more desired functions, where such protectable-content elements may be separately and/or individually licensed/owned, and those skilled in the art will recognize that aggregated-content elements can also be combined with other aggregated and/or non-aggregated content elements to form content elements that exhibit relatively higher levels of aggregation;

“aggregated license” refers to a license that sets forth restrictions for an aggregated-content element;

“content” (also referred to herein as “protectable content,” “protectable-content element,” or “constituent protectable-content element”) refers, separately or in any combination, to one or more multimedia presentations, video segments, audio segments, textual representations, works of art, visual representations, technological know-how (e.g., manufacturing processes), business know-how (e.g., marketing information), contract rights, software elements (e.g., open source software compliant with an open source definition, proprietary software not compliant with an open source definition, etc.), and/or any other type of matter/representation that may be legally-protectable under patent law, copyright law, trademark law, trade secret law, contract law, and/or under other legal bases;

“data structure” refers to a database table, a linked list, and/or any other type of data format or configuration that enables a data set to be referenced;

“digital data processing device” refers to a personal computer, computer workstation, laptop computer, server computer, mainframe computer, handheld device (e.g., personal digital assistant, Pocket PC, cellular telephone, etc.), information appliance, or any other type of generic or special-purpose processor-controlled device that is capable of receiving, processing, and/or transmitting digital data;

“event” refers to one or more errors, warnings, conflicts, and/or other types of occurrences that may occur when evaluating, aggregating, and/or otherwise processing license attributes;

“event information” refers to information that may be stored in corresponding event data structures and may include, for example, an event type (e.g., copyright detection, author detection, license attribute conflict, etc.), an event counter that specifies a frequency of occurrence for a particular event, indicia pertaining to a use and/or interaction value associated with an event, and/or indicia (e.g., a name/identifier, a value, a type, and/or a directory path associated with one or more aggregated-content elements and/or protectable-content elements) pertaining to a source of information associated with an event;

“license” refers to a collection of clauses (e.g., license terms) that set forth restrictions (e.g., requirements, obligations, grants, prohibitions, limitations, etc.) that may affect a use (e.g., distribution), interaction (e.g., modification, combination), and/or other manipulation of protectable content;

“license alternatives” refers to one or more licenses that may be suitable for a particular operational/deployment environment of an aggregated-content element;

“license attributes” refers to representations of license restrictions that may be processed by software processes executing on one or more digital data processing devices, and can exhibit one or more values that may facilitate an attribute-by-attribute analysis of two or more protectable-content elements that form at least part of an aggregated content, such as, for example, one or more restriction values (which can specify an applicability of one or more license attributes to a content element by, for example, specifying if such attributes are required, prohibited, not applicable, true, false, or the like), use values (which can represent a permissible degree of distribution associated with one or more license attributes), and/or interaction values (which can represent a permissible degree of manipulation associated with one or more license attributes);

“license authority” refers to one or more software processes (e.g., software processes that handle requests, analyze protectable content, evaluate licenses, aggregate licenses, provide substantially unique identifiers of the licenses and protectable content, and/or assess risk) that operate on protectable content, licenses, license profiles, and/or other types of data and parameters so as to serve as a trusted, third-party entity between owners and users/manipulators of protectable content that can authenticate the validity of licenses, identify content owners, and/or determine risk measures that may be used to insure against potential legal/financial liability that may be incurred if a content owner's rights in a particular protectable content are infringed by an unwitting content user/manipulator;

“license profile” refers to a collection of license attributes associated with a particular protectable content and/or a particular license;

“object code” refers to a compiled version of source code that is understood by a processor of a digital data processing device, but which is difficult to understand and/or manipulate by a human;

“processor” refers to logic circuitry that responds to and processes instructions that drive digital data processing devices and can include, without limitation, a central processing unit, an arithmetic logic unit, an application specific integrated circuit, a task engine, and/or any combinations, arrangements, or multiples thereof;

“software code” refers to source code and/or object code;

“software process” refers to a set of executable instructions, operations, variables, parameters, data, data structures, software drivers, plug-ins, and/or any other types of elements that are needed to form an execution environment sufficient to perform the desired functionality of a process, and those skilled in the art will recognize that the functionality described for a particular software process can be incorporated into one or more other processes and that the software processes themselves can be otherwise combined, separated, and/or organized without adversely affecting the operation of the disclosed technology and thus are intended merely for illustrative purposes;

“source code” refers to programming statements generated by and/or readily identifiable by a software programmer; and

“substantially” refers to an indication of a precise relationship, condition, arrangement, orientation, and/or other characteristic as well as deviations thereof, as understood by one of ordinary skill in the art, to the extent that such deviations do not materially affect the disclosed methods and systems.

Overview

Unless otherwise specified, the illustrated embodiments can be understood as providing exemplary features of varying detail of certain embodiments, and therefore, unless otherwise specified, features, components, processes, elements, data, attributes, attribute values, and/or aspects of the illustrations can be otherwise combined, interconnected, sequenced, separated, interchanged, relocated/repositioned, and/or rearranged without departing from the disclosed systems or methods. Additionally, the shapes, sizes, and orientations of elements are also exemplary and, unless otherwise specified, can be altered without affecting the disclosed technology.

By way of non-limiting example and with reference to an embodiment in which protectable content refers to software elements, a non-exclusive list of license attributes that may be associated with such software elements can include one or more software code formats (e.g., requirement for providing access to source code if executable code is distributed, requirement to make newly-added software code available in a source code format, requirement to distribute newly-added source code under terms of a particular license, etc.), software naming conventions (e.g., requirement that non-original software files be renamed to avoid conflict with names of original software files), software code annotations (e.g., requirement that a notification be added to modified executable and/or source code), warranties (e.g., disclaimer of warranties and liability for original source code), fees (e.g., allowing warranty fees, distribution/media cost-recovery fees, and/or software program fees associated with one or more software elements, etc.), reverse-engineering activities (e.g., requirement that distributed and/or newly-added software code be capable of reverse-engineering), patent litigation activities (e.g., contingency in which initiation of a patent litigation terminates a license), standards bodies (e.g., requirement that newly-added software code conform to applicable standards specified by a particular standards body), violations of intellectual property rights (e.g., requirement that contributors of new software code warrant that such new code is free of intellectual property violations and that all applicable rights have been properly secured, prohibition against using the name and trademarks associated with an original software element and/or original author in promoting modified software code, etc.), and/or textual descriptions of corresponding licenses (e.g., requirement to include the actual text of an original license when distributing corresponding software code, requirement to include explanatory license text for software modifications, requirement to display notifications during execution of software code, requirement to provide license text regarding a distribution term and/or attribution procedures, etc.). As described above, restriction values can specify an applicability of one or more such license attributes to a software element by, for example, specifying if such attributes are required, prohibited, not applicable, true, false, etc.

Continuing with the exemplary software element embodiment, use values assigned to one or more license attributes can, for example, correspond to an acquisition, a personal use, a research and development use, an organizational use (e.g., a deployment of software code within an organization in a form that may exceed personal use and/or research and development use), a limited distribution use (e.g., a deployment of software code without wide distribution), and/or an unlimited distribution use (e.g., a distribution of software code to unrelated entities) of at least one aspect of a software element. Similarly, interaction values assigned to one or more license attributes can, for example, correspond to an original software element (e.g., unmodified source code), a modified software element (e.g., original source code files that have been altered by the addition of new code or the deletion of some original code), a group of distinct software elements (e.g., a collection of original and added source code files forming a software module), a group of interconnected software elements (e.g., a collection of original and/or added source code and object code files forming a library, where such files are meant to be linked with other software elements), a group of software elements capable of providing one or more functions (e.g., software code capable of being compiled into an executable software application program, software code capable of providing separate and interoperable software application programs, etc.), an unrestricted manipulation of software elements, and/or an unrestricted ownership of software elements.

Collaborative development environments in which individuals, organizations, and/or other entities engage in joint intellectual, artistic, and/or other expressive efforts to advance/expedite development in an area of interest may necessitate interactions with protectable content that may be proprietary to one or more of such entities. Restrictions affecting a use (e.g., distribution), interaction (e.g., modification or combination), and/or other manipulation of protectable content can be stipulated by an owner of such content in license terms set forth, for example, in one or more license agreements that may enable interested parties to use and/or interact with the content in a manner that facilitates collaboration, while concurrently avoiding infringement of the content owner's rights in such protectable content. The likelihood of infringing a content owner's rights in protectable content is particularly acute in situations in which two or more protectable-content elements are combined and/or otherwise manipulated to form an aggregated content, which may be subject to the restrictions of its constituent protectable-content elements as may be set forth as terms in one or more licenses.

License Dependency Resolution

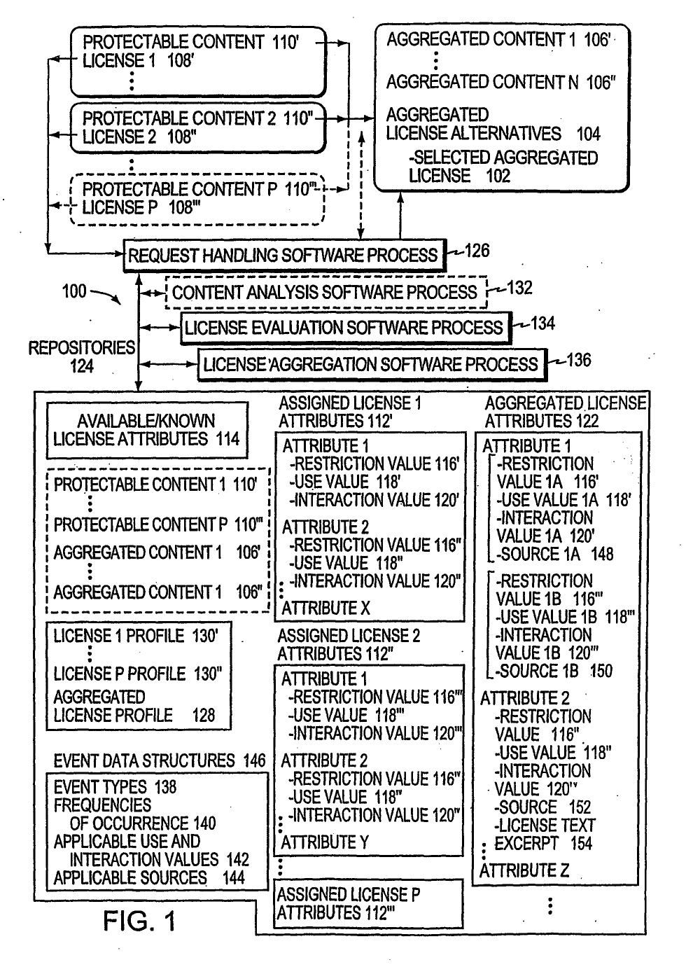

In brief overview of a first aspect of the invention, and with reference to the illustrative embodiment shown in FIG. 1, a collaboration architecture 100 employing aspects of the disclosed technology can be used to select/identify an aggregated license 102, from perhaps a multitude of aggregated license alternatives 104, that sets forth restrictions affecting one or more aggregated-content elements 106, where such restrictions are based, at least in part, on restrictions contained within licenses 108 associated with protectable content 110 that forms such aggregated content 106. The restrictions contained within such constituent protectable-content licenses 108 can be represented as license attributes 112 that are drawn from a set of known/available license attributes 114 and such license attributes 112 can be assigned one or more restriction values 116, use values 118, and/or interaction values 120, which facilitate a comparative attribute-by-attribute analysis of the constituent protectable-content licenses 108 and thus enables the identification of aggregated license attributes 122 and associated values that form the basis for one or more aggregated license alternatives 104.

Although one or more of the exemplary embodiments provided herein describe applications of at least some aspects of the disclosed technology to a pair of licenses 108′, 108″ and/or a pair of protectable content elements 110′, 110″, those skilled in the art will recognize that the disclosed technology can be applied to substantially any number of licenses, license combinations, protectable content elements, and/or protectable content element combinations/aggregations and, thus, such exemplary embodiments are merely illustrative and are not intended to be limiting in any respect. Further, and although one or more of the exemplary embodiments provided herein describe comparative attribute-by-attribute analyses of license attributes 112 in which a particular attribute/attribute value of a first license 108′ is compared with a corresponding attribute/attribute value of a second license 108″, those skilled in the art will recognize that the disclosed technology can be applied to a wide variety of attribute/attribute value analyses such as, for example, when two or more attributes/attribute values of a first license 108′ are compared with each other and/or with one or more attributes/attribute values of one or more other licenses to identify aggregated license attributes 122 and associated values that form a basis for one or more aggregated license profiles 128 and/or aggregated license alternatives 104 and, thus, such exemplary embodiments are merely illustrative and are not intended to be limiting in any respect. By way of non-limiting example and with reference to an embodiment in which protectable content refers to software elements, two distinct attributes and their associated attribute values of a first exemplary license may require that access to original (unmodified) source code and access to added source code (e.g., source code that is added to the original source code) be made available to a user if corresponding executable code is distributed to the user, but these two attributes and associated attribute values may conflict with, for example, a single attribute/attribute value of a second exemplary license that may prohibit distribution of source code. The corresponding attributes and associated attribute values of the resulting aggregated license profile, in this non-limiting example, may therefore include indicia representative of such distribution incompatibilities.

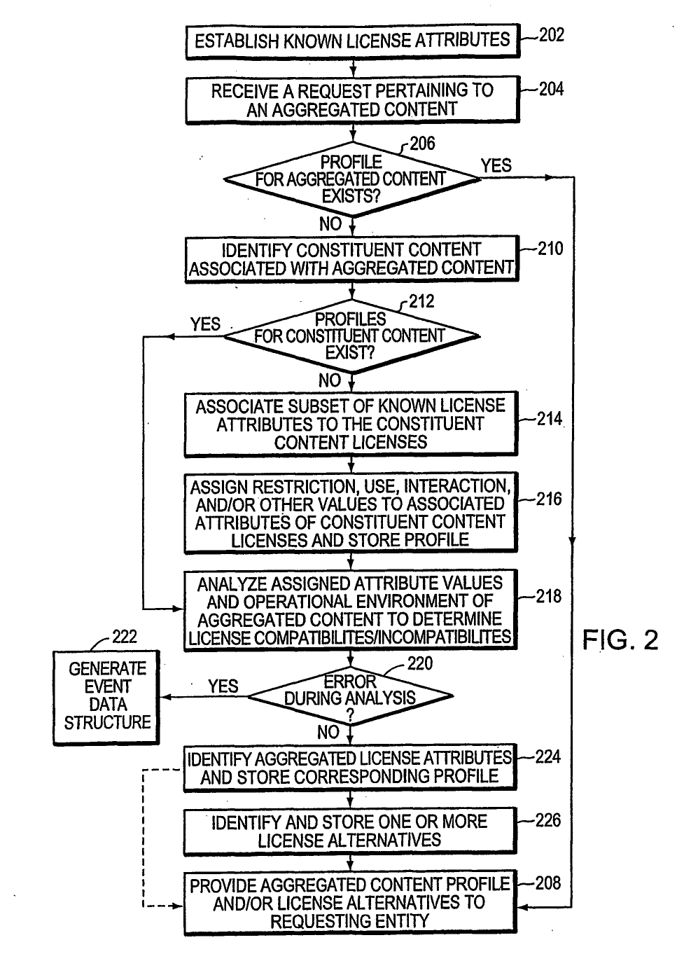

In more detail and with reference now also to an illustrative operation as shown in FIG. 2, an administrator and/or other entity (not shown) authorized to configure a collaboration architecture 100 employing at least some aspects of the disclosed technology can identify known types of license attributes 114 that may be associated with one or more protectable-content elements 110 and can make such known license attributes 114 available in one or more repositories 124 (e.g., databases) to support subsequent attribute-processing activities that may involve the collaboration architecture 100 (202). The known license attributes 114 can, for example, represent types of license restrictions that may occur in licenses that affect transactions in one or more industries (e.g., music industry, software industry, etc.) and/or operational environments.

Once the repository 124 of the collaboration architecture 100 is populated with known license attributes 114, a request handling software process 126 can receive a request to, for example, identify one or more license alternatives 104 and/or aggregated license attributes 122 associated with an aggregated content of interest 106 (204). The aggregated content of interest 106 can, for example, correspond to aggregated content that already exists, aggregated content that is currently under development, and/or aggregated content that is being considered for development. As will be recognized by those skilled in the art, a request can be provided to the request handling software process 126 via an electronic message (e.g., electronic mail message), an electronic document (e.g., an electronic file), an input data stream (e.g., keyboard and/or mouse actions), a web page, and/or in any other manner which enables the request handling software process 126 to reliably receive and identify information pertaining to an aggregated content of interest 106 (e.g., name and/or other indicia of the aggregated content 106, name and/or other indicia of the constituent protectable-content elements 110 that form such aggregated content 106, license information associated with the aggregated content 106 and/or constituent protectable content 110, etc.).

In response to receiving a request, the request handling software process 126 can search one or more repositories 124 to ascertain whether one or more license profiles 128 of the aggregated content 106 are stored therein (206). If an aggregated license profile 128 exists, the request handling software process 126 can provide the requesting entity with such license profile 128 and/or with one or more corresponding aggregated license alternatives 104, from which a selected aggregated license 102 maybe selected (208). If an aggregated license profile 128 is not located within one or more of the repositories 124, the request handling software process 126 can identify constituent protectable-content elements 110 (which may also be stored in one or more of the repositories 124) that form the aggregated content of interest 106 from information contained within the received request and/or by instructing a content analysis software process 132 to analyze the aggregated content of interest 106 (which may also be stored in one or more of the repositories 124) to identify its constituent protectable-content elements 110 by, for example, searching for particular segments of software code, embedded copyright information, embedded license information, embedded ownership information, embedded version information, and/or any other type of indicia useful in identifying the constituent protectable-content elements 110 (210). Similarly, licenses 108 associated with the constituent protectable content 110 can be identified from information contained within the received request and/or from information embedded in the constituent protectable content 110 and discovered by the content analysis software process 132.

In response to identifying the licenses 108 (which may also be stored in one or more repositories 124) associated with the constituent protectable-content elements 110, the request handling software process 126 can make a determination whether one or more license profiles 130 representing such licenses 108 exist by, for example, searching one or more repositories 124 for such profile information (212). This determination can affect whether a license evaluation software process 134 needs to initially form one or more new license profiles 130 for the licenses 108 of the constituent protectable-content elements 110 (in the case where license profiles 130 do not exist) prior to analyzing the attribute values of such protectable content 110 to identify compatibilities and/or incompatibilities in their corresponding licenses 108.

For example, if license profiles 130 for the licenses 108 of constituent protectable-content elements 110 do not yet exist, the request handling software process 126 can instruct a license evaluation software process 134 to evaluate the licenses 108 to determine relevant subsets of the known license attributes 114 that may be assigned/associated to represent such licenses 108 (214). The license evaluation software process 134 can identify relevant subsets of the known license attributes 114 by, for example, mapping restrictions contained within license terms in the licenses 108 to particular known license attributes, evaluating information contained within the request received by the request handling software process 126 that pertains to the licenses 108 and/or associated license restrictions, and/or based on additional information provided by the requesting entity and/or administrator/authorized user of the collaboration architecture 100. Once the relevant subsets of the known license attributes 114 have been identified and assigned to represent the licenses 108 of the constituent protectable-content elements 110, the license evaluation software process 134 can further analyze the licenses 108 to assign one or more restriction values 116 (specifying an applicability of an associated attribute), use values 118 (specifying a permissible degree of distribution that may cause an associated attribute to become applicable), interaction values 120 (specifying a permissible degree of manipulation that may be associated with a particular attribute), and/or other values (e.g., license text excerpts and/or other license identifying information associated with an attribute) to one or more of the assigned attributes 112 and these attributes and attribute values can be stored in one or more license profiles 130 in a repository 124, which may facilitate future processing activity within the collaboration architecture 100 if and/or when such licenses 108 are encountered again (216).

Although the assigned attributes 112 in the FIG. 1 embodiment indicate that corresponding restriction, use, and interaction values 116-120 are assigned to each of the attributes 112, those skilled in the art will recognize that one or more of such values 116-120, separately or in any combination, need not be assigned to any particular attribute 112 and that the illustrated embodiment is merely exemplary of one possible embodiment and is not intended to be limiting in any respect. Further, the licenses 108 of one or more constituent protectable content elements 110 can include license terms that specify default distribution and/or manipulation restrictions that may be represented as common use and/or interaction values for at least some of the attributes 112 of corresponding license profiles 130, although the disclosed technology can also accommodate particular use and/or interaction values that may override such common/default values as required. In one illustrative embodiment, default restrictions in license terms can be represented as use, interaction, and/or other types of values that can be shared among license attributes 112 by, for example, assigning such default values to corresponding attributes (that do not have any overriding values that supersede the default values), assigning pointers and/or other indicia to the corresponding attributes so that default values can be referenced and taken into account during subsequent processing activities, and/or via any other method or mechanism which provides access to such default values during processing activities performed by a license aggregation software process 136, whose functionality is further described below.

Upon completion of the license profiles 130 and/or if such license profiles 130 previously existed, a license aggregation software process 136 can analyze the attribute values 116-120 of one or more attributes 112 associated with the constituent protectable-content elements 110 forming at least part of an aggregated content 106 in view of an intended operational/deployment environment and/or other operational parameters associated with the aggregated content 106 to determine specific attribute and/or attribute value compatibilities and/or incompatibilities between the licenses 108 of such constituent protectable-content elements 110 (218). If an incompatibility and/or other type of error, warning, and/or information is detected during this analysis (and which is not already identified as an attribute value) (220), the license aggregation software process 136 can generate event data such as, for example, an event type 138, a frequency of occurrence 140 of an event, indicia of use and/or interaction values associated with an event 142, and/or other indicia that may pertain to a source of information for the event and such event data can be stored in one or more event data structures 146, which may be stored as part of one or more license profiles 128, 130 and/or as separate data structures within one or more repositories 124 (222). The event data structures 146 can be useful in resolving incompatibilities between licenses 108 that may be specific to such licenses 108 and thus may not have been otherwise accounted for in values 116-120 assigned to corresponding license attributes 112. For example, event data 138-144 stored within one or more event data structures 146 can be communicated to an entity that submitted a corresponding request that was received by the request handling software process 126 and/or to other interested entities (e.g., one or more content owners or entities affiliated with such content owners that are associated with the protectable content 110 and/or aggregated content 106) and such entities can seek waivers, new license terms, a redesign of the aggregated content 106, a modification of the operational/deployment environment of the aggregated content 106, new design alternatives, and/or other types of corrective action that can mitigate the risk of infringing a content owner's rights in the protectable content 110 and/or aggregated content 106 associated with the detected incompatibilities. In addition to detecting and resolving incompatibilities, event data structures 146 can also include warnings and/or other information that may be addressed in a more subtle manner than that discussed above, such as by, for example, identifying text (e.g., notices describing operational boundaries associated with the operational/deployment environment of the aggregated content 106) that needs to be inserted into one or more aggregated license alternatives 104 associated with the aggregated content 106.

In more detail and with respect to one illustrative embodiment, a license aggregation software process 136 can compare one or more attribute values 116′-120,′ 116″-120″ associated with one or more license attributes 112″ of a first license 108′ with one or more corresponding attribute values 116′″-120′″, 116^{iv}-120^{iv} associated with one or more license attributes 112″ of a second license 108″ to identify aggregated license attributes 122 associated with an aggregated content of interest 106. Aggregated license attributes 122 can be stored as one or more aggregated license profiles 128 in one or more repositories 124, which may facilitate future processing activity within the collaboration architecture 100 if/when such aggregated license profiles 128 are needed again (224). Attributes and attribute values of the first license 108′ can be compared with corresponding attributes and attribute values of the second license 108″ in an attribute-by-attribute and/or attribute value-by-attribute value manner to ensure that any compatibilities and/or incompatibilities that may be associated with the combination of protectable content elements 110′, 110″ to form an aggregated content 106, targeted for deployment/operation in a particular manner/environment, are identified at a level of granularity sufficient to reliably detect potential/actual infringement risks associated with particular aspects of the aggregated content 106. Similarly, the attribute-by-attribute and/or attribute value-by-attribute value comparison can serve as a basis for determining whether particular aspects of the aggregated content 106 are governed by the attributes/license terms of the first license 108′, the attributes/license terms of the second license 108″, and/or any combinations (e.g., one or more of the attributes and/or attribute values of the first license 108′ may govern an aspect of the aggregated content 106, while one or more of the attributes and/or attribute values of the second license 108″ may govern a different aspect of the aggregated content 106) and/or hybrids thereof (e.g., attribute values associated with an attribute of the first license 108′ and attribute values associated with an attribute of the second license 108″ may be assigned to a common attribute of the aggregated content 106 and thus coexist as further discussed below, one or more attribute values associated with an attribute of the first license 108′ may override attribute values associated with an attribute of the second license 108″ in some situations or be overridden thereby in other situations, etc.). Those skilled in the art will recognize that this type of analysis can be performed for any number of attributes, attribute values, and/or licenses and that the disclosed embodiments are merely illustrative and are not intended to be limiting in any respect.

In one embodiment, the restriction, use, and/or interaction values 116′-120′ assigned to an attribute 112″ of a first license 108′ may coexist with one or more of the restriction, use, and/or interaction values 116′″-120′″ assigned to an attribute 112″ of a second license 108″ if such values do not result in a dominant or subservient relationship that would necessitate a modification in the attribute values of a corresponding aggregated license attribute 122 (see, for example, the attribute values assigned to Aggregated License Attribute 1 in FIG. 1). For example, one or more coexisting values and/or value sets 116′- 120′ and 116′″-120′″ for a first attribute of an aggregated content 106 may reflect optional occurrences within an operational/deployment environment, such as when, for example, license fees are forbidden when the aggregated content 106 is used for research and development purposes, but fees are required when the aggregated content 106 is widely distributed. In this manner, the disclosed technology can be used to generate one or more aggregated license alternatives 104, based on attributes whose values may accommodate a diverse spectrum of occurrences within one or more operational/deployment environments. Those skilled in the art will recognize that multiple values and/or value sets can be assigned to a wide variety of different attribute types and that the disclosed examples and embodiments are merely illustrative and are not intended to be limiting in any respect.

In one embodiment, one or more restriction, use, and/or interaction values 116″-120″ assigned to an attribute 112″ of a first license 108′ may dominate or be subservient to one or more restriction, use, and/or interaction values 116^{iv}-120^{iv} assigned to an attribute 112″ of a second license 108″, which may necessitate that attribute values of a corresponding aggregated license attribute (see, for example, Aggregated License Attribute 2 in FIG. 1) reflect a combination of attribute values associated with the corresponding attributes of the first and second license 108′, 108″ (which may occur if there is partial domination or subservience) or reflect one set of attribute values in the case where there is complete domination or subservience. For example, a restriction value of an attribute associated with a first license may be more restrictive (e.g., recite a requirement or prohibition of the associated attribute) than a restriction value of an attribute associated with a second license (e.g., when a neutral/don't care value is specified), in which case the restriction value of the first license governs the combination of such values and is thus represented as a restriction value to a corresponding attribute of an aggregated content. Similarly, use and/or interaction values of an attribute associated with a first license may also be more or less restrictive than use and/or interaction values of an attribute associated with a second license and the selection of the controlling values for the corresponding attribute of the aggregated content can be based, at least partly, on the relative restrictiveness of such values. In this manner, the disclosed technology can be used to generate one or more aggregated license alternatives 104 based on attributes whose values reflect the more restrictive aspects of constituent protectable content licenses and which thus mitigate the risk of infringing one or more of such licenses in a particular operational/deployment environment.

In one illustrative embodiment, an aggregated license profile 128 and/or one or more other data structures stored within a repository 124 of the collaboration architecture 100 can include content-descriptive information (not shown) that characterizes one or more aspects of the aggregated content 106 itself, rather than or in addition to the aggregated license attributes 122 and associated attribute values that pertain to license terms of one or more aggregated license alternatives 104. By way of non-limiting example and with respect to an exemplary embodiment in which an aggregated content 106 refers to an aggregation of one or more software elements, content-descriptive information can correspond to manipulations/interactions of at least some aspects of constituent protectable content elements 110 that form such aggregated content 106 and can, for example, specify whether the aggregated content 106 includes a software library formed from a combination of source code from the constituent protectable content elements 110, whether the aggregated content 106 includes a software application formed from a combination of software libraries from the constituent protectable content elements 110, and/or the like.

In one illustrative embodiment, an aggregated license profile 128 and/or one or more other data structures stored within a repository 124 of the collaboration architecture 100 can include profile-override information (not shown) that can be used to, for example, add/modify/delete one or more attributes 112 and/or associated attribute values in a license profile 130 of a constituent protectable content element 110 that forms an aggregated content of interest 106, so as to accommodate special situations where, for example, a user of the aggregated content 106 obtains a waiver and/or otherwise negotiates with an authorized owner of the constituent protectable element 110 to obtain license terms that differ from those originally expressed in a license 108 of the constituent protectable content 110 and which enable the user to interact with the aggregated content 106 in a desired manner. Accordingly, the profile-override information can be used by a license evaluation software process 134 and/or license aggregation software process 136 to custom-design license profiles 130 and aggregated license profiles 128 for particular users and/or particular operational/deployment environments. By way of non-limiting example and with reference to an embodiment in which protectable content 110 refers to one or more software elements, a potential distributor of an aggregated software product 106 who wants to distribute such product 106, but is prevented from doing so because of distribution incompatibilities in the license terms of its constituent software elements 110, can obtain authorization from an authorized content owner to modify particular license terms that cause such incompatibilities so that the aggregated software product 106 can be distributed as desired. The authorization obtained from the content owner can be represented as profile-override information that can override (e.g., add, modify, delete) one or more attributes/attribute values of a license profile 130 that governs one or more of such constituent software elements 110 and when such attributes and attribute values are combined, by a license aggregation software process 136, with corresponding attributes and attribute values of other constituent license profiles 130, the resulting aggregated license profile 128 and/or aggregated license alternatives can reflect such overridden attributes/attribute values that enable the distributor of the aggregated software product 106 to distribute such aggregated software product 106 as authorized/desired. Those skilled in the art will recognize that profile-override information is one example of various types of data/information that can be stored within an aggregated license profile 128 and/or other data structure in the repository 124 of the collaboration architecture to describe and/or affect how a particular aggregated license profile 128 was formed.

Additional values that may be assigned to aggregated license attributes 122 and/or stored in source data structures (not shown) may include source information/values 148-152 (e.g., indicia pertaining to related license clauses/attributes, storage location within a repository 124, etc.), license text excerpts 154 (that may be used to explain particular aggregated license attributes 122), and/or any other type of information that may be useful in characterizing/profiling an aggregated content of interest 106. Source information and associated values 148-152 assigned to aggregated license attributes 122 can provide information that is useful in identifying and/or locating the license attributes 112 and/or attribute values 116, 120 associated with constituent protectable content 110 that participated in the formation and/or assignment of the aggregated license attributes 122 and/or values. A source value 148 assigned to a particular aggregated license attribute 122 and/or stored in a source data structure can, for example, identify a file name, a license name/identifier, a directory path of a license and/or license attribute, a particular location within a file, a list of associated protectable content 110, a list of associated aggregated content 106, and/or any other type of information that is useful in tracking and reporting issues and/or other information pertaining to processing activity performed by the license aggregation software process 136 during its formation of the aggregated license attributes. In one embodiment, the source information 148-152 can be used in concert with event data 138-144 stored in the event data structures 146 to identify and locate those elements of the collaboration architecture 100 that were processed and that contributed to particular event types, thereby facilitating troubleshooting and/or other remedial activities. Similarly text, such as license text excerpts 154 from one or more licenses 108, may be included/assigned to one or more aggregated license attributes 122 and may include, for example, modification instructions, distribution information, author attribution information, operational notices (e.g., software runtime notices), publishing information, transferability information, devices/platforms that may be used together with the aggregated content, governing jurisdictions, and/or any other type of information that is useful in forming one or more aggregated license alternatives, resolving incompatibilities, and/or providing information that mitigates a likelihood of infringement. In this manner, license text excerpts 154 and/or other textual information can facilitate the formation of aggregated license alternatives (and may be included entirely or partly in such licenses) and/or facilitate the resolution of incompatibilities.

Those skilled in the art will recognize that more than one aggregated license profile 128 may exist for a particular aggregated content 106, particularly where one or more of its constituent protectable-content elements 110 can be governed by more than one license 108. In such situations, multiple aggregated license profiles 128 can be formed to represent the various permutations of licenses and associated license attributes. Particular aggregated license profiles 128 that are not compatible with an operational environment of the corresponding aggregated content of interest 106 can be discarded. Otherwise one or more aggregated license profiles 128 that are viable relative to the operational environment of the aggregated content 106 can be used by the license aggregation software process 136 to generate, identify, and/or store one or more aggregated license alternatives 104 for the aggregated content 106 (226). In one embodiment, the license aggregation software process 136 can generate the license alternatives 104 by, for example, mapping the aggregated license attributes 122 and associated attribute values to license clause templates that can be updated to represent the desired license alternatives. In one embodiment, the request handling software process 126 can provide the aggregated content profile 128 for an aggregated content of interest 106 to a requesting entity that can subsequently use the profile information to generate the legal language forming the aggregated license alternatives 104 and the resulting license alternatives can be subsequently stored in one or more repositories.

In more detail and with respect to one illustrative embodiment, the operation, deployment, and/or manipulation of a particular protectable content element 110 can be governed by one of several different license alternatives. In order to support the combination of at least some aspects of this protectable content 110 with that of other protectable content, which may also be governed by more than one license, to form an aggregated content 106, the disclosed technology can process the various permutations in license alternatives by, for example, performing an attribute-by-attribute and/or attribute value-by-attribute value comparison for the attributes in these sets of license alternatives. For example, if a first protectable content has two license alternatives (e.g., L1 and L2) and a second protectable content has three license alternatives (e.g., L3, L4, and L5), the disclosed technology can process permutations of such licenses that may include combinations involving license pairs LIL3, LIL4, LIL5, L2L3, L2L4, and L2L5. Those skilled in the art will recognize that the disclosed technology can be applied to any number of licenses, protectable content elements, and/or other license combinations that may differ from license pairs (e.g., if three or more protectable content elements are being aggregated, then the license combinations may, but need not, involve three or more licenses per combination) and that the disclosed embodiments are merely exemplary. As previously discussed, license profiles 130 for one or more of licenses L1-L5 that provide license attribute information, including restriction, use, and/or interaction values for such attributes, may already exist in a repository 124 and/or can be generated using the license evaluation software process 134.

Upon identifying/generating the license profiles 130 for licenses L1-L5, the license aggregation software process 136 can compare, sequentially or in parallel, the attribute values of attributes associated with L1 with corresponding attribute values of attributes associated with L3 for license combination L1L3 and for each of the other combination pairs. As previously described, processing information associated with the license evaluation software process 134 and/or license aggregation software process 136 can be tracked and stored within one or more repositories and can include, for example, license profiles 130, event data 138-144 in one or more event data structures 146, aggregated license attributes and values (e.g., dominant values, subservient values, coexisting values, source values, license text excerpts, etc.). The processed and stored information can be used to identify aggregated license alternatives that are based on the various license combinations and can facilitate the selection of a preferred aggregated license for a particular operational/deployment environment. As the number of license aggregation operations performed by the disclosed technology increases, the performance of the collaboration architecture 100 may also increase since the data stored in the repositories 124 may already include the license profiles 130, aggregated license profiles 128, and/or other processing data that can facilitate the generation, evaluation, and/or selection of aggregated license alternatives.

The various software processes 126, 132, 134, 136, processing operations, repositories 124, content 106, 110, known license attributes 114, assigned attributes 112, attribute values 116-120, 148-152, license profiles 128, 130, entity types, event data structures 146 and associated event data 138-144, and/or other elements of the collaboration architecture 100 can operate on and/or otherwise be associated with one or more digital data processing devices (not shown) that may be interconnected by a network (not shown).

The instructions executed by a processor represent, at a low level, a sequence of “0's” and “1's” that describe one or more physical operations of a digital data processing device. These instructions can be pre-loaded into a programmable memory (e.g., EEPROM) that is accessible to the processor and/or can be dynamically loaded into/from one or more volatile (e.g., RAM, cache, etc.) and/or non-volatile (e.g., hard drive, etc.) memory elements communicatively coupled to the processor. The instructions can, for example, correspond to the initialization of hardware within a digital data processing device, an operating system that enables the hardware elements to communicate under software control and enables other computer programs to communicate, and/or software application programs/software processes that are designed to perform particular functions for an entity or other computer programs, such as functions relating to processing license registration requests and/or license authentication requests.

A local user can interact with a digital data processing device by, for example, viewing a command line, graphical, and/or other user interface and entering commands via an input device, such as a mouse, keyboard, touch sensitive screen, track ball, keypad, etc. The user interface can be generated by a graphics subsystem of a digital data processing device, which renders the interface into an on or off-screen surface (e.g., in a video memory and/or on a display screen). Inputs from the user can be received via an input/output subsystem and routed to a processor via an internal bus (e.g., system bus) for execution under the control of the operating system.

Similarly, a remote user can interact with a digital data processing device over a data communications network. The inputs from the remote user can be received and processed in whole or in part by a remote digital data processing device collocated with the remote user. Alternatively or in combination, the inputs can be transmitted back to and processed by the local digital data processing device or to another digital data processing device via one or more networks using, for example, thin client technology. The user interface of the local digital data processing device can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices typically require a network subsystem (e.g., as embodied in a network interface card) to establish the communications link between the devices. The communications link interconnecting digital data processing devices can include elements of a data communications network, a point to point connection, a bus, and/or any other type of digital data path capable of conveying processor-readable data.

A data communications network (e.g., Internet, intranets, etc.) can comprise a series of network nodes that can be interconnected by network devices and communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from a source node to a destination node regardless of any dissimilarities in the network topology (e.g., bus, star, token ring), spatial distance (local, metropolitan, or wide area network), transmission technology (e.g., TCP/IP, Systems Network Architecture), data type (e.g., data, voice, video, or multimedia), nature of connection (e.g., switched, non-switched, dial-up, dedicated, or virtual), and/or physical link (e.g., optical fiber, coaxial cable, twisted pair, wireless, etc.) between the source and destination network nodes.

License Authentication

In another aspect, the disclosed technology can mitigate the risk of infringing a content owner's rights in protectable content by operating as a trusted, third-party license authority between content owners and content users to ensure that a license governing at least some aspects of the protectable content is authentic and thus validly represents the restrictions imposed by content owners pertaining to the use, distribution, modification, combination, interaction, and/or other manipulation of such content.

The disclosed technology can also be used in determining a measure of risk that pertains to a level of confidence that a particular license is authentic. In one illustrative embodiment, the disclosed technology can be used to determine a license profile for a particular license of interest and the risk measure can be based, at least in part, on the entity that developed such license profile. For example, a relatively high risk measure that represents a relatively low-level of confidence that a particular license is authentic and/or that such license adequately identifies a content owner's rights in a protectable content of interest may be encountered if the content owner generates a corresponding license profile without the benefit of automated content analysis and/or license evaluation software tools/processes and/or without involvement of a third-party entity to validate the accuracy of the license profile. Similarly, a relatively moderate risk measure that represents a relatively medium-level of confidence that a particular license is authentic and/or that such license adequately identifies a content owner's rights in a protectable content of interest may be encountered if a content owner employs automated content analysis and/or license evaluation software tools/processes to generate a corresponding license profile, but does not validate the accuracy of the license profile using a third-party entity. Further, a relatively low risk measure that represents a relatively high-level of confidence may be encountered if automated content analysis and/or license evaluation software tools/processes are used to generate the corresponding license profile and one or more third-party (independent) entities validate the accuracy of such license profile.

The risk measure and/or confidence level can serve as a basis for risk assessment, or for example for completion of one or more entries in an actuarial data structure (e.g., database table), which can subsequently be used to determine one or more provisions in an insurance contract (e.g., pertaining to a premium) that may insure particular content users, manipulators, and/or aggregators for potential liability that may arise upon infringement of a content owner's rights in protectable content. In one embodiment, relatively low risk measures and high confidence levels may enable content users/aggregators to purchase liability insurance for potential infringement of protectable content at a favorable premium, whereas moderate risk measures and confidence levels may result in higher premiums and relatively high risk measures and low confidence levels may result in more burdensome premiums or may perhaps result in a lack of insurance carriers willing to engage in such liability insurance contracts.

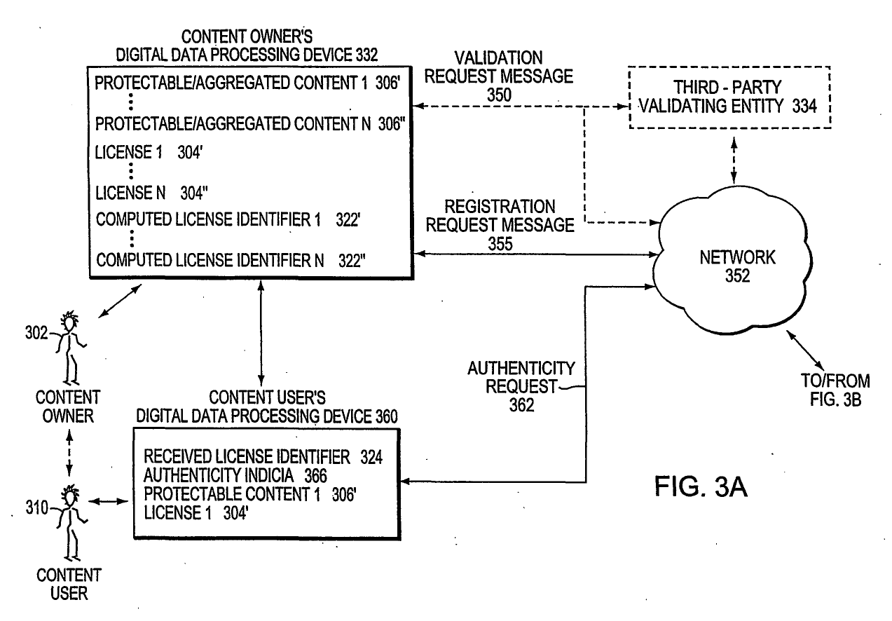

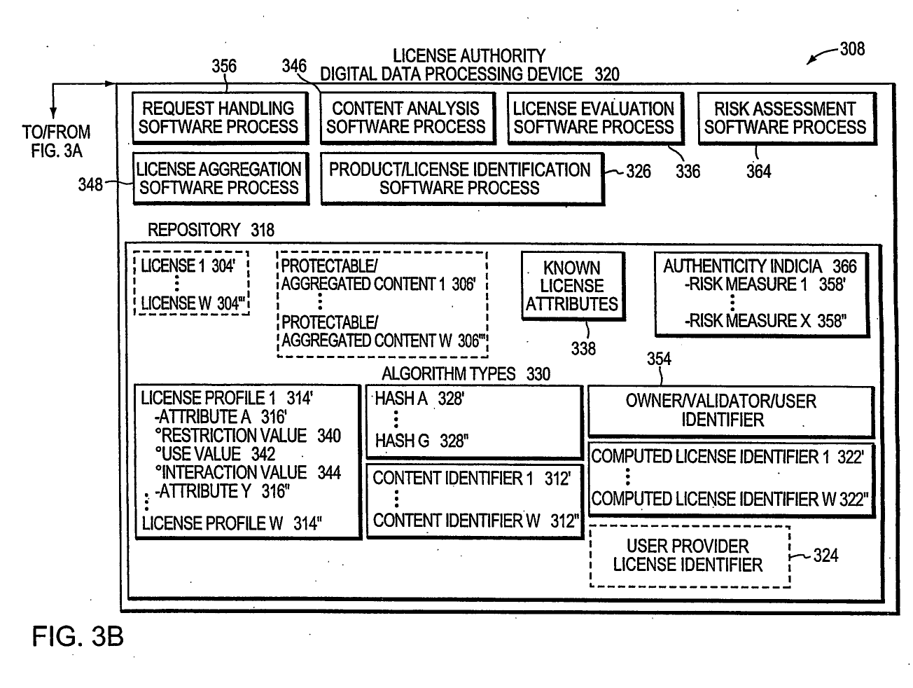

In brief overview and with reference to an illustrative embodiment of at least some aspects of the disclosed technology as shown in FIGS. 3A and 3B, a content owner 302 (and/or other entities/software processes authorized to act on behalf of such content owner 302) can register one or more licenses 304 of one or more protectable and/or aggregated content elements 306 with a trusted, third-party entity (e.g., the license authority 308), which can subsequently authenticate the validity of such licenses 304 and their applicability to particular protectable content elements 306, upon request by one or more users 310 of such content 306. Licenses 304 for particular protectable content elements 306 can be registered with a license authority 308 by, for example, generating content identifiers 312 that substantially uniquely identify particular protectable content elements of interest 306, generating one or more license profiles 314 that represent attributes 316 of corresponding licenses 304, and storing such content identifiers 312 and license profiles 314 within a repository 318 residing in and/or otherwise accessible to a digital data processing device 320 supporting the operations of the license authority 308. The license authority 308 can compute an identifier 322 that substantially uniquely represents a license 304 and its association with a corresponding protectable content 306 based, at least in part, on the license profile 314 and content identifier 312 associated therewith. A content owner 302 can provide the computed license identifier 322 to a content user 310 prior to, concurrently, or after providing the user 310 with the corresponding protectable content 306 and the user 310 can authenticate the validity and applicability of the content's license 304 by, for example, requesting that the license authority 308 confirm that the license identifier 324 received from the content owner 302 is substantially equivalent to the license identifier 322 previously computed by such license authority 308.

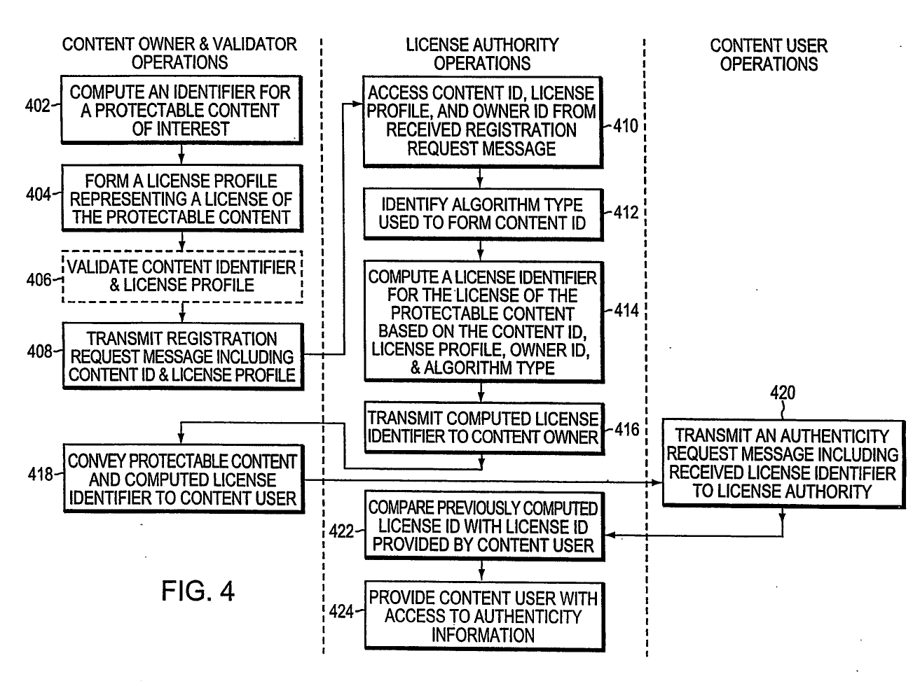

In more detail and with reference now also to an illustrative operation as shown in FIG. 4, a content owner 302 can provide a product/license identification software process 326 with access (e.g., network access, web access, and/or any other type of direct or indirect access) to one or more protectable/aggregated content elements of interest 306 and such software process 326 can apply one or more hash algorithms 328 and/or other algorithm types 330 to the protectable/aggregated content elements of interest 306 to compute a content identifier 312 thereof (402). Those skilled in the art will recognize that the particular hash algorithm 328 used to transform characters within the protectable/aggregated content elements 306 into one or more representative values (i.e., content identifiers 312) may employ, for example, a division remainder method, a folding method, a radix transformation method, a digit rearrangement method, a secure hash method, an MD2 method, an MD4 method, an MD5 method, and/or any other type of methodology, technique, or algorithm that can substantially uniquely identify protectable/aggregated content elements of interest 306. Although the illustrative embodiment shown in FIGS. 3A and 3B shows that the protectable/aggregated content 306 is located on a content owner's digital data processing device 332, those skilled in the art will recognize that such content can be located within a repository 318 associated with a digital data processing device 320 of the license authority 308, a repository (not shown) associated with a digital data processing device (not shown) of a third-party validating entity 334, and/or in any other type of storage media communicatively coupled to the software processes of the license authority 308. Further, one or more aspects of the product/license identification software process 326 (and/or one or more aspects of other software processes of the license authority 308) and/or associated algorithm types 330 (e.g., hash algorithms 328) can be performed on digital data processing devices that are different from that of the license authority 308 such as, for example, on a content owner's digital data processing device 332, on a digital data processing device associated with a third-party validating entity 334, and/or on any other digital data processing device communicatively coupled to the digital data processing device 320 of the license authority 308.

Prior to, concurrently, or following the computation of a content identifier 312 for a particular protectable/aggregated content of interest 306, a content owner 302 and/or a third-party validating entity 334 can access a license evaluation software process 336 of the license authority 308 to evaluate one or more licenses 304 associated with a particular protectable/aggregated content of interest 306 to determine relevant subsets of known license attributes 338 that may be assigned/associated to represent such licenses 304 in one or more license profiles 314 (404). Known license attributes 338 can, for example, represent types of license restrictions that may occur in licenses that affect transactions in one or more industries (e.g., music industry, software industry, etc.) and/or operational environments. The license evaluation software process 336 can identify relevant subsets of the known license attributes 338 by, for example, mapping restrictions contained within license terms in the licenses 304 to particular known license attributes, evaluating information provided by a content owner 302, evaluating information provided by a third-party validating entity, and/or based on information provided by any other authorized entity and/or software process. Once the relevant subsets of the known license attributes 338 have been identified and assigned to represent the licenses 304 of the protectable/aggregated content 306, the license evaluation software process 336 can further analyze the licenses 304 to assign one or more restriction values 340 (specifying an applicability of an associated attribute), use values 342 (specifying a permissible degree of distribution that may cause an associated attribute to become applicable), interaction values 344 (specifying a permissible degree of manipulation that may be associated with a particular attribute), and/or other values (e.g., license text excerpts and/or other license identifying information associated with an attribute) to one or more of the assigned attributes 316 and these attributes and attribute values can be stored in one or more license profiles 314 in a repository 318 accessible by one or more digital data processing devices 320, 332, which may facilitate future processing activity within the licensing authority architecture 308 if and/or when such licenses 304 are encountered again. Although the assigned attributes 316 in the FIG. 3B embodiment indicate that corresponding restriction, use, and interaction values 340-344 are assigned to each of the attributes 316, those skilled in the art will recognize that one or more of such values 340-344, separately or in any combination, need not be assigned to any particular attribute 316 and that the illustrated embodiment is merely exemplary of one possible embodiment and is not intended to be limiting in any respect. Further, the licenses 304 of one or more protectable content elements 306 can include license terms that specify default distribution and/or manipulation restrictions that may be represented as common use and/or interaction values for at least some of the attributes 316 of corresponding license profiles 314, although the disclosed technology can also accommodate particular use and/or interaction values that may override such common/default values as required. In one illustrative embodiment, default restrictions in license terms can be represented as use, interaction, and/or other types of values that can be shared among license attributes 316 by, for example, assigning such default values to corresponding attributes (that do not have any overriding values that supersede the default values), assigning pointers and/or other indicia to the corresponding attributes so that default values can be referenced and taken into account during subsequent processing activities, and/or via any other method or mechanism which provides access to such default values during processing activities performed by one or more software processes of the license authority 308.

In an embodiment in which a license 304 for a particular protectable/aggregated content of interest 306 does not exist, has not been identified, and/or is not accessible by one or more of the software processes of the license authority 308, the content owner 302 and/or third-party validating entity 334 can instruct a content analysis software process 346 to analyze the protectable/aggregated content of interest 306 to identify an applicable license 304 and/or license profile 314 thereof (if such license profile already exists). The content analysis software process 346 can, for example, search for particular character strings (e.g., segments of software code), embedded copyright information, embedded license information, embedded ownership information, embedded version information, and/or any other type of indicia useful in identifying a license 304 of a protectable/aggregated content of interest 306. Once the content analysis software process 346 has identified the license 304, the license evaluation software process 336 can form a corresponding license profile 314 as previously described, if such license profile 314 does not already exist.

In one illustrative embodiment, a content owner 302 may seek to register an aggregated content 306 that includes two or more constituent protectable content elements with the license authority 308 in which case, the license evaluation software process 336 can evaluate the terms in an aggregated license 304 to form an aggregated license profile 314, as discussed above (assuming that such aggregated license 304 exists). However, in embodiments where an aggregated license does not exist and/or is not accessible, the license evaluation software process 336 can form license profiles 314 representing licenses of the aggregated content's constituent protectable content elements and a license aggregation software process 348 of the license authority 308 can analyze the attributes and attribute values of such constituent license profiles to determine specific attribute and attribute value compatibilities and/or incompatibilities that can be used to form an aggregated license profile and/or aggregated license for the aggregated content of interest. The functionality provided by the license evaluation software process 336 and the license aggregation software process 348 is described above with respect to, for example, license evaluation software process 134 and license aggregation software process 136, respectively.

With continuing reference to FIGS. 3A, 3B, and 4, a content owner 302 can convey a protectable/aggregated content of interest 306, a corresponding content identifier 312, a corresponding license 304, and/or a corresponding license profile 314 to a third-party validating entity 334 by, for example, including one or more of such elements 306, 312, 304, 314 in a validation request message 350 (which may be encrypted and digitally signed) that is transmitted to the third-party validating entity 334 directly or via a network 352. Alternatively, the validation request message 350 can provide information (e.g., user identifier and/or password) to the third-party validating entity 334, which enables such entity 334 to access the protectable/aggregated content of interest 306, the corresponding content identifier 312, the corresponding license 304, and/or the corresponding license profile 314 (e.g., via a secure web site).

In response to receiving the validation request message 350, the third-party validating entity 334, which may (but need not) be associated with the license authority 308, can access one or more of the product/license identification, content analysis, license evaluation, and/or license aggregation software processes 326, 346, 336, 348 that may be operating locally and/or on the digital data processing device 320 of the license authority 308 and apply one or more of such processes 326, 346, 336, 348 to one or more of the protectable/aggregated content of interest 306, the corresponding content identifier 312, the corresponding license 304, and/or the corresponding license profile 314 to form a validated content identifier and/or validated license profile (406). The validated content identifier and/or validated license profile can be compared with corresponding content identifiers and/or corresponding license profiles formed by the content owner 302 (if any such identifiers or profiles were computed by the content owner) to identify errors and/or inconsistencies therein. The validated content identifier, validated license profile, identifier 354 of the content owner 302, identifier 354 of the third-party validating entity, and/or other related data/information (e.g., the protectable/aggregated content 306, license 304, etc.) can be incorporated into a registration request message 355 (e.g., an electronic mail message, an electronic file, a stream of digital data packets, etc.) that may be encrypted, digitally signed, and transmitted to a request handling software process 356 of the license authority 308 via the network 352 for registration (408).

As previously described, the particular mechanism used to generate and convey a content identifier 312 and/or license profile 314 to a license authority 308 can determine a measure of risk 358 that may for example be relevant to, or used to affect, one or more provisions in an insurance contract, which insures interested parties from unwittingly infringing a content owner's rights in a protectable/aggregated content 306. For example, a relatively low measure of risk 358 may be obtained when a third-party validating entity 334 employs product/license identification, content analysis, license evaluation, and/or license aggregation software processes 326, 346, 336, 348 to form the content identifier 312 and/or license profile 314 for a particular protectable/aggregated content 306 as compared with a relatively high measure of risk 358 that may be obtained when a content owner does not use a third-party validating entity 334 or the software processes 326, 346, 336, 348 of the license authority 308.

Upon receipt of a registration request message 355 from a content owner 302 or third-party validating entity 334, a request handling software process 356 can decrypt, parse, and/or otherwise process the message 355 to access the content identifier 312 associated with a protectable/aggregated content of interest 306, the license profile 314 representing a license 304 associated with the protectable/aggregated content of interest 306, the identifier 354 identifying the content owner 302, and/or any other information that may be contained therein (e.g., protectable/aggregated content 306, license 304, identifier 354 of the third-party validating entity, indicia pertaining to the mechanism/procedure used to form the content identifier 312 and/or license profile 314, etc.) (410). The request handling software process 356 can analyze the format (e.g., number of digits, alphanumeric sequences, etc.) of the content identifier 312 to identify the particular algorithm type 330 used to form such content identifier 312 (412). The request handling software process 356 can further instruct a product/license identification software process 326 to compute a license identifier 322 that substantially uniquely identifies the license 304 of the protectable/aggregated content of interest 306 by applying, for example, one or more algorithm types 330 (e.g., hash algorithms 328) to the content identifier 312, license profile 314, owner/validator identifier 354, and/or algorithm type 330 used to form the content identifier 312 (414). The request handling software process 356 can store the computed license identifier 322, content identifier 312, identified algorithm type 330, license profile 314, owner/validator identifier 354, protectable/aggregated content 306, license 304, and/or other related information in one or more repositories 318 communicatively coupled to the digital data processing device 320 of the license authority 308 and can associate such elements in one or more data structures (not shown) to effectuate registration of the license 304 and/or protectable/aggregated content 306.

Once the license 304 and/or protectable/aggregated content are registered, the request handling software process 356 can form a reply message that transmits the resulting computed license identifier 322 to the content owner 302 (416). The content owner 302 can electronically distribute (e.g., incorporate into an email message, make available on a web site, etc.) and/or otherwise convey (e.g., mail a CD, DVD, floppy disk, and/or other media) the computed license identifier 322, the associated protectable/aggregated content 306, the associated license 304, and/or other data/information to one or more content users 310 (418). In one embodiment, the computed license identifier 322 can correspond to a code that enables the protectable/aggregated content 306 to partially or fully operate. Upon receipt of the information transmitted from the content owner 302, the content user 310 may want to confirm that such information is authentic and has not been tampered with and/or otherwise manipulated by unauthorized parties. Accordingly, the content user 310 can instruct one or more software processes (not shown) executing on a digital data processing device 360 accessible to the content user 310, such as processes associated with a web browser software application, to form and transmit an authenticity request message 362 that may be encrypted and digitally signed and which includes a license identifier 324 received from the content owner 302 to the request handling software process 356 of the license authority 308 (420).

Upon receipt of the authenticity request message 362, the request handling software process 356 can decrypt and/or otherwise manipulate the message 362 to access the license identifier 324 transmitted by the content user 310. The request handling software process 356 can instruct a risk assessment software process 364 to authenticate the received license identifier 324 by, for example, comparing the received license identifier 324 with the computed license identifier 322 that was previously formed and transmitted by the software processes of the license authority 308 to the content owner 302 to confirm that the license identifiers 324, 322 are substantially equivalent (422). If the license identifiers 322, 324 are not substantially equivalent, then the request handling software process 356 can form and transmit a reply message to the content user 310 that the license identifier 324 received from the content owner 302 by the content user 310 has failed authentication. If the risk assessment software process 364 determines that the license identifiers 322, 324 are substantially equivalent, the process 364 can form authenticity indicia 366 (e.g., one or more risk measures 358) that can be transmitted to and/or otherwise accessed by the content user 310 (424).

Authenticity indicia 366 can be interpreted to inform the content user 310 of a risk of infringing a content owner's rights in a protectable/aggregated content of interest 306 that may be based on, for example, a content owner's authority to license the content of interest 306 (e.g., whether the content owner 302 has full or partial rights to license the content 306 and/or whether the rights of other content owners may be infringed), a tampering and/or other unauthorized manipulation of the content 306 and/or associated license 304 (e.g., whether unauthorized entities have improperly modified, copied, distributed, and/or otherwise manipulated the content 306, whether entities are perpetrating a fraud on the content user 310 by feigning a lawful interest in the content 306, etc.), and/or on any other bases that expose a content user 310 to a risk of infringing a content owner's rights in a content of interest 306. Authenticity indicia 366 can include, for example, one or more of the following, separately or in any combination: a validated/authenticated content identifier 312, a validated/authenticated protectable/aggregated content 306, a validated/authenticated license 304, a validated/authenticated license profile 314, and/or one or more risk measures 358. Authenticity indicia 366 that has been validated and/or authenticated can indicate to the content user 310 that the license authority has authenticated the validity of such indicia and/or associated content 304 and/or data and has a particular confidence in the accuracy and reliability of such content/data, as expressed in one or more of the risk measures 358.

Risk measures 358 can be computed by the risk assessment software process 364 based on, for example, numerical weights that can be associated with the type of entities involved in the formation of the content identifier 312 and license profile 314 of a protectable/aggregated content of interest 306. For example, greater numerical weights can be applied to content identifiers 312 and license profiles 314 that are formed by automated software processes 326, 346, 336, 348 and independent, third-party validating entities 334 than to content identifiers 312 and license profiles 314 that are formed by a content owner 302 and without having the benefit of one or more automated processes 326, 346, 336, 348 and/or validating entities 334. The relatively greater numerical weights encountered by using automated processes 326, 346, 336, 348 and independent third-party validating entities 334 can correspond to a relatively higher confidence level (relatively low risk level) that a license 304 of a protectable/aggregated content 306 is accurate and reliable and may thus present little, if any, risk of infringing a content owner's rights in a content of interest 306. Similarly, relatively smaller numerical weights encountered when automated processes 326, 346, 336, 348 and/or validating entities 334 are not used can correspond to a relatively lower confidence level (relatively high risk level) that a license 304 of the protectable/aggregated content 306 is accurate and reliable and may thus present a significant and quantifiable infringement risk. Risk measures 358 that are computed from such exemplary numerical weights can be incorporated into one or more actuarial tables that can form the basis for one or more provisions of an insurance contract targeted at insuring against potential infringement. Accordingly, content users 310, content distributors, content aggregators, insurance carriers, and/or other interested entities can use such risk measures 358 to formulate a liability insurance contract, negotiate better license terms with content owners 302, increase an end-user price of such content 306, and/or otherwise mitigate potential legal and/or financial liability prior to using and/or otherwise interacting with the content 306.

In one illustrative embodiment, a measure of risk 358 that may form an entry in an actuarial risk table can be determined from an equation whose variables are based on an accuracy/reliability of a license profile 314 and/or on an association/correlation between a license profile 314 and a particular protectable/aggregated content of interest 306. These variables can lie within a continuum, from a relatively low accuracy/correlation to a relatively high accuracy/correlation. For example, a variable based on an accuracy of a license profile 314 can exhibit increasing values as the accuracy of the license profile 314 increases in the following exemplary continuum (from low to high accuracy): a) a license profile 314 is not formed for a protectable content of interest 306, b) a license profile 314 is partially formed for a protectable content of interest 306 by a content owner 302 of such content 306, c) a license profile 314 is fully formed for a protectable content of interest 306 by a content owner 302 of such content 306, d) an aggregated license profile 314 is fully formed by an aggregated content owner for an aggregated content of interest that includes two or more constituent protectable content elements, e) an aggregated license profile 314 is fully formed by analyzing a relatively high level portion of an aggregated content of interest using one or more automated software processes 326, 346, 336, 348, f) an aggregated license profile 314 is fully formed by comprehensively analyzing an aggregated content of interest, including an analysis of its constituent protectable content elements, using one or more automated software processes 326, 346, 336, 348, g) an aggregated license profile 314 is fully formed by comprehensively analyzing an aggregated content of interest, including an analysis of its constituent protectable content elements, using one or more automated software processes 326, 346, 336, 348 and where license profiles of the constituent protectable content elements are validated by a third-party validating entity 334, h) same as prior element, except also validate the aggregated license profile 314 using the third-party validating entity 334, and i) same as prior element, except also have the third-party validating entity 334 form the aggregated and constituent license profiles using the automated software processes 326, 346, 336, 348. Similarly, a variable based on a correlation between a license profile 314 and its associated protectable/aggregated content 306 can exhibit increasing values as the correlation between such profile 314 and content 306 increases in the following exemplary continuum (from low to high correlation): a) there is no correlation between a license profile 314 and a particular protectable/aggregated content of interest 306, b) a content owner 302 of a protectable/aggregated content 306 specifies that the content 306 and associated profile 314 are correlated, c) a content owner 302 of a protectable/aggregated content 306 specifies that the content 306 and associated profile 314 are correlated and the identity of such content owner 302 is verified by an independent third-party entity (e.g., a third-party validating entity 334, a digital certificate authority, a license authority 308, etc.), d) same as prior element, except also submit the protectable/aggregated content 306 and associated profile 314 to the independent third-party entity, which can subsequently confirm the identity of the submitted content 306 and profile 314 (by, for example, issuing a digital certificate indicative of such confirmed identity), and e) same as prior element, except also have the independent third-party entity analyze the contents of the protectable/aggregated content 306 relative to the associated profile 314 to confirm/verify a correlation between such content 306 and profile 314 (by, for example, issuing a digital certificate indicative of such confirmed/verified correlation).

Verification of Protectable Content

In general, in another aspect, the present invention pertains to methods and systems for verifying protectable content. In broad overview, in accordance with this aspect of the invention, a first computing device receives, for example from a second computing device, a protectable content. Together with the protectable content, the first computing device may also receive one or more licenses or references to one or more licenses that purportedly govern (e.g., permit) the use and/or distribution of the protectable content, and/or may also receive other information pertaining to the protectable content and/or the one or more licenses that purportedly govern (e.g., permit) the use and/or distribution of the protectable content. In one embodiment, upon receiving the license(s) and/or other information, the first computing device verifies that the license(s) do in fact govern the use and/or distribution of the protectable content.

In one non-limiting example, the protectable content is an aggregation of computer programs, computer files, and/or computer code. In such a case, to help verify that the one or more licenses do in fact govern the use and/or distribution of the protectable content, the first computing device decomposes the protectable content into components, for example in a hierarchical fashion as hereinafter described. To ascertain the protectable content's components, the first computing device may, as illustrative examples, investigate one or more directories of the protectable content, investigate one or more compressed archives, investigate one or more install files, investigate one or more binaries, investigate one or more “makefiles” for the protectable content, and/or investigate one or more “include files” for the protectable content. Having ascertained the protectable content's components and having decomposed the protectable content into its components, the first computing device then reviews each component to determine its identity and, having done so, retrieves for each component a known profile associated with its identity. The known profile may be, for example, the origin of the component and/or one or more sets of license terms that are known to govern the use and/or distribution of the component. The first computing device then compares the known profile against a stated profile for the component. The stated profile, for example the stated origin of the component and/or the stated license terms that purportedly govern the use and/or distribution of the component, may be determined from the license(s) and/or other information originally provided to the first computing device together with the protectable content. If, for each component of the protectable content, the known profile is found to match the stated profile, the one or more licenses provided together with the protectable content do in fact govern the use and/or distribution of the protectable content. If, however, a known profile for any component of the protectable content is not found to match the stated profile for that component, the one or more licenses provided together with the protectable content do not govern the use and/or distribution of the entire protectable content.

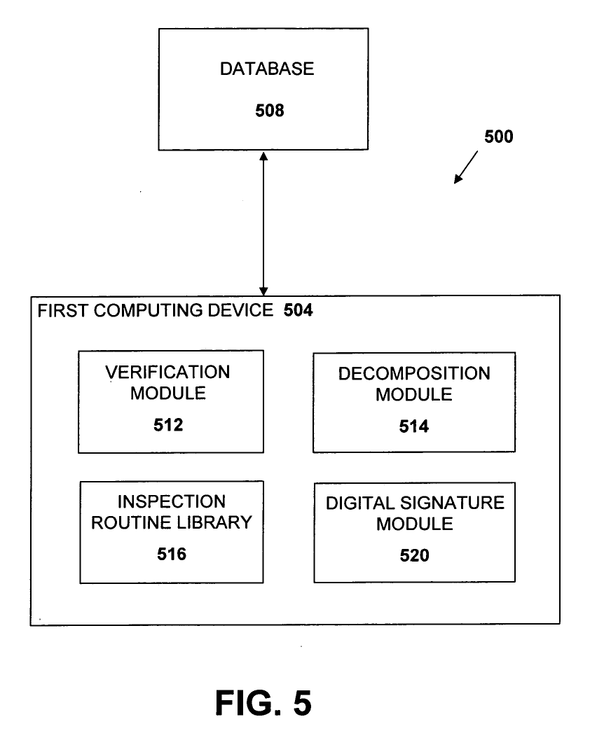

FIG. 5 depicts a system 500 for verifying protectable content according to an illustrative embodiment of this aspect of the invention. The system 500 includes a first computing device 504 in communication with a database 508. The database 508 may be on the same, or as shown, a separate device from, but local to, the first computing device 504. In such a case, the first computing device 504 and the database 508 communicate directly without the use of a network. Alternatively, in another embodiment (not shown), the database 508 is remote from the first computing device 504 and the two communicate over a network. In such a case, the network may be, for example, a local-area network (LAN), such as a company Intranet, or a wide area network (WAN), such as the Internet or the World Wide Web. The first computing device 504 may be connected to the network through a variety of connections including, but not limited to, standard telephone lines, LAN or WAN links (e.g., T1, T3, 56 kb, X.25), broadband connections (e.g., ISDN, Frame Relay, ATM), or wireless connections. The connections, moreover, may be established using a variety of communication protocols (e.g., HTTP, TCP/IP, IPX, SPX, NetBios, Ethernet, RS232, and direct asynchronous connections). In yet another embodiment (not shown), the functionality of the database 508 is included on the first computing device 504.

The first computing device 504 may be any personal computer, Windows-based terminal, Network Computer, wireless device, information appliance, RISC Power PC, X-device, workstation, mini computer, main frame computer, personal digital assistant, set top box, handheld device, mobile telephone, or other computing device that is capable of both presenting information/data and receiving commands. Referring back to FIG. 3A, the first computing device 504 may be, for example, the third party validating entity 334, the license authority digital data processing device 320, or the content user's digital data processing device 360.

For its part, the database 508 may be any logic and/or computing device that is capable of storing and managing collections of data, and of delivering information/data to, and receiving commands from, the first computing device 504. The database 508 may communicate using SQL or another language, or may use other techniques to store and receive data.

In one embodiment, the first computing device 504 includes a verification module 512 for verifying a protectable content. Optionally, the first computing device 504 may also include a decomposition module 514 for decomposing the protectable content into components, an inspection routine library 516 for storing inspection routines used by the verification module 512, and a digital signature module 520 for digitally signing the protectable content. The verification module 512 and the decomposition module 514 may each be implemented as any software program and/or hardware device, for example as an application specific integrated circuit (ASIC) or as a field programmable gate array (FPGA), that is capable of achieving the functionality described below. For its part, the digital signature module 520 may also be implemented as any software program that is capable of achieving the functionality described below.

Where the verification module 512 is implemented as a software program, it may load one, two, or more inspection routines from the inspection routine library 516 to inspect the component of the protectable content at issue. Alternatively, in another embodiment, the verification module 512 is implemented as a software program that is preprogrammed with its own inspection routines and the inspection routine library 516 is not used. In still another embodiment, where the verification module 512 is implemented as a hardware device, the inspection routine library 516 is either not used or is replaced by further hardware devices for use in connection with the verification module 512.

It should be understood that two or more of the verification module 512, the decomposition module 514, and the digital signature module 520 may be combined into a single module, such that the functions performed by the two or more modules 512, 514, and 520, as described below, are in fact performed by the single module. In addition, it should be understood that any single one of the modules 512, 514, and 520 may be implemented as multiple modules, such that the functions performed by any single one of the modules 512, 514, and 520, as described below, are in fact performed by the multiple modules.

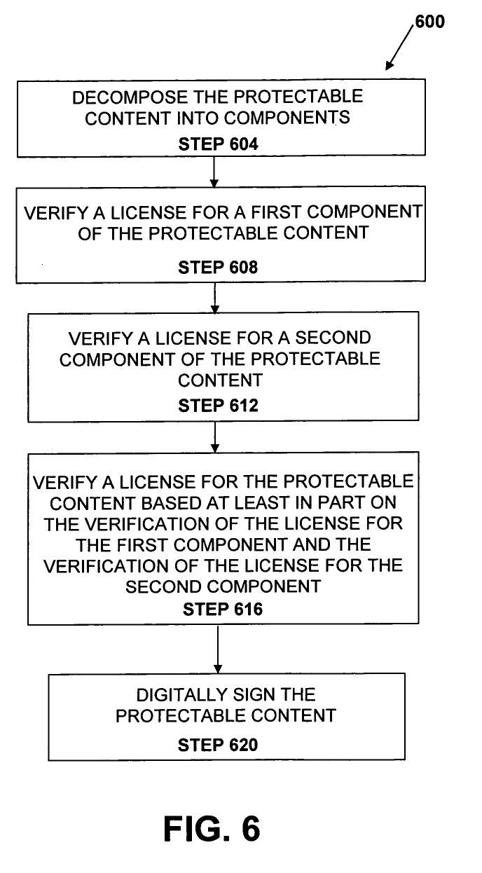

Referring now to FIG. 6, in one embodiment of a method 600 for verifying protectable content, for example using the system 500 of FIG. 5, a license for a first component of the protectable content may be verified at step 608, a license for a second component of the protectable content may be verified at step 612, and a license for the protectable content may be verified at step 616. The verification at step 616 may be based at least in part on the verification of the license for the first component and on the verification of the license for the second component.

Optionally, prior to performing steps 608, 612, and 616, the protectable content may be decomposed into components, for example into first and second components. It should be understood that the protectable content can be decomposed into more than two components, for example into three, four, or any number of components, although only two are described for simplicity. In such embodiments, the method 600 can include, in addition to steps 608 and 612 for verifying the licenses of the first and second components, further steps for verifying the licenses of the third, fourth, and nth components. In such embodiments, the verification at step 616 may, in addition to being based on the verification of the license for the first component and on the verification of the license for the second component, be based on the verifications of the licenses for the third, fourth, and nth components.

In addition, the method 600 may optionally include digitally signing the protectable content. As illustrated in FIG. 6, the protectable content may be digitally signed at step 620 after steps 608, 612, and 616 have been performed.

In greater detail, prior to performing step 604 of the method 600, the first computing device 504 of the system 500 receives a protectable content. The protectable content may be received, for example, from a second computing device (not shown) that is in communication, over a network or otherwise, with the first computing device 504. Together with the protectable content, the first computing device 504 may also receive one or more licenses or references to license information that purportedly govern the use and/or distribution of the protectable content, and/or may also receive other information pertaining to the protectable content and/or the one or more licenses that purportedly govern the use and/or distribution of the protectable content. In one embodiment, for example, the first computing device 504 receives a license for every component of the protectable content. Alternatively, in another embodiment, some or all of the licenses received by the first computing device 504 govern two or more components of the protectable content.

At step 604, the decomposition module 514 decomposes the protectable content into components. In one embodiment, where the protectable content is an aggregation of computer programs, computer files, and/or computer code, the decomposition module 514 investigates a directory of the protectable content to ascertain the protectable content's components and thereafter decomposes the protectable content into those components. In other embodiments, the decomposition module 514 investigates a compressed archive, an install files, a binary file, a “makefile” and/or an “include file” for the protectable content (or one or more of these, or a combination of these) to ascertain its components and thereafter decomposes the protectable content into those components. In another embodiment, the decomposition module reviews or “scans” the code and compares it to previously stored code to ascertain its components. One skilled in the art will recognize that other techniques may also be used to decompose the protectable content into components such as those techniques described below.

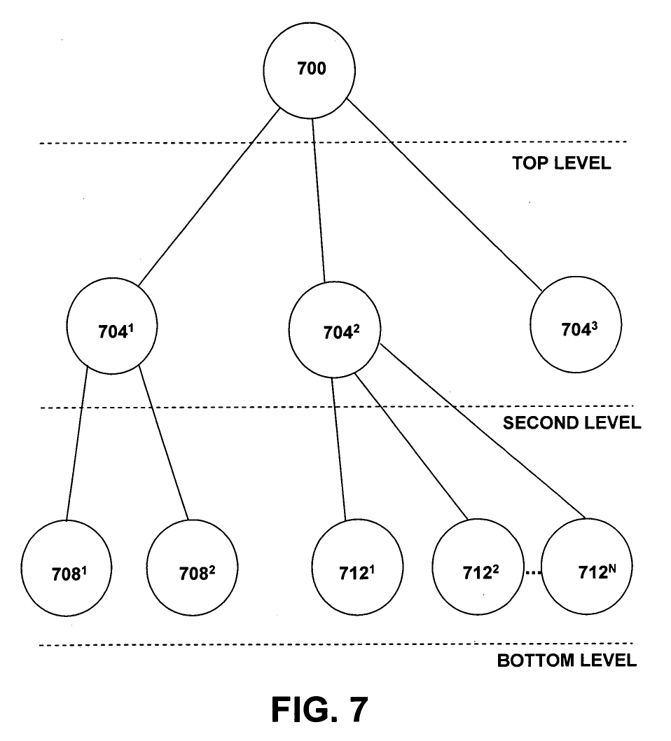

In one embodiment, the decomposition module 514 decomposes the protectable content in a hierarchical fashion. For example, referring now to FIG. 7, when presented with a top-level protectable content 700, the decomposition module 514 decomposes the top-level protectable content into its components (e.g., the three second-level components 704¹, 704², and 704³). Having decomposed the top-level protectable content 700 into its components 704¹, 704², and 704³, the decomposition module 514 then attempts to decompose each second level protectable content 704¹, 704², and 704³ into its components. For example, second-level protectable content 704¹ is decomposed into two third-level components 708¹ and 708², and second-level protectable content 704² is decomposed into n third-level components 712¹ to 712ⁿ. The decomposition module 514 continues to decompose each level of protectable content as just described until each level of protectable content cannot be further decomposed. Referring still to FIG. 7, the decomposition module 514 may determine, for example, that each of the second-level protectable content 704³ and the third level protectable contents 708¹, 708², and 712¹ to 712ⁿ do not include any components and cannot be further decomposed.

After the decomposition module 514 decomposes the protectable content at step 604 of the method 600, the verification module 512 is used to verify the protectable content. In one embodiment, the verification module 512 begins to verify the protectable content by verifying licenses for the components of the protectable content at the bottom-level of the hierarchical structure just described. For example, in one embodiment, the verification module 512 starts with protectable content 704¹ and its components 708¹ and 708². In such an embodiment, the verification module 512 verifies, at step 608, a license for the first component 708¹ of the protectable content 704¹, and verifies, at step 612, a license for the second component 708² of the protectable content 704¹.

In one embodiment, the verification of the license for the first component 708¹ at step 608 includes determining, by the verification module 512, the identity of the first component 708¹. Similarly, in one embodiment, the verification of the license for the second component 708² at step 612 includes determining, by the verification module 512, the identity of the second component 708². Any suitable technique that is helpful in determining the identity of the first and second components 708¹, 708² (e.g., what they are) may be used by the verification module 512 at steps 608 and 612 of the method 600, and various embodiments of such techniques are described below. It should be understood, however, that the features of the various techniques described below are not mutually exclusive and can exist in various combinations and permutations, even if such combinations or permutations are not made express herein, without departing from the spirit and scope of the invention. For example, in determining the identity of a given component 708¹, 708², the verification module 512 may employ one of the techniques described below, or two or more of the techniques described below, for example in combination. Some of the techniques may involve the use of the database 508; others may not.

In one embodiment, the verification module 512 inspects tokens in the component 708¹, 708². Where the component 708¹, 708² is computer code, the verification module 512 may inspect tokens derived from the source code or from the object code of the computer code. The tokens can take a variety of forms. For example, in one implementation, the verification module 512 breaks the source code or object code down into discrete subsets of code and then, for each discrete subset of code, evaluates a hash function to generate a hash value. The generated hash values, or a subset thereof, may then be transmitted to the database 508. The database 508 compares the hash values received from the first computing device 504 against a collection of known hash values for discrete subsets of code. When the comparison yields a match, the database 508 notifies the first computing device 504 of the identity of the component 708¹, 708².

In another exemplary implementation using tokens, the verification module 512 generates a token for each word, or symbol, in the computer code. Each word or symbol has an assigned token. The code is thus translated to tokens, which tokens are then compared, for example individually, summarily, (i.e., some but not all), or in proximate groups, to determine the identity of the component 708¹, 708².

In another exemplary implementation, the verification module 512 generates a token for each item in the code, in a manner similar to tokens generated by a compiler. For example, each token may include a pair of integers, where the first integer is the class of token representing a code element (e.g., START, END, FUNCTION CALL, SYMBOL, CONSTANT, LITERAL, OPERATION, etc.) and the second integer identifies the member of the class (e.g., for class OPERATION, members can include without limitation ADD, SUBTRACT, COMPARE; and for class SYMBOL, the token member might be the string name of the symbol, or an identifier assigned to the string name). The tokens that are generated may then be compared to tokens stored in the database 508, for example individually or in adjacent or nearby token groups, to determine the identity of the component 708¹, 708². In some embodiments, for some symbol classes, only the token class types are compared. For example, for CONSTANTS and LITERALS, it may be enough to know that a CONSTANT occupied a location between an OPERATION/ADD token and an OPERATION/MULTIPLY token. The combination of some token members, in proximity to some token classes, for example, may be indicative of the identity of the component 708¹, 708². Use of this technique enables the verification module 512 to identify code that is functionally equivalent, but has been subject to non-functional, textual changes such as a global search and replace of variable names.

As another example, for Java code, the code may be compiled into bytecode tokens, and the compiled bytecode tokens compared. Although the compiled output may be compiler specific, if the same Java compiler is used to generate the tokens that are used for comparison, any anomalies due to compiler differences can be minimized. As in the example above, if desired, steps can be taken to minimize the impact of any non-functional, textual differences, such that the comparison focuses on functional similarity as represented in a group of adjacent or nearby tokens.

In one embodiment, the verification module 512 inspects the structure of the component 708¹, 708². For example, where the component 708¹, 708² is a source code file or an object code file, the verification module 512 may inspect the code, or subsets thereof, and generate representations of how the code is structured (e.g., representations of what certain routines, sub-routines, functions, loops, etc. use as parameters, variables, constants, etc.). The generated representations may then be transmitted to the database 508 for comparison against a collection of known source code or object code structure representations. When the comparison yields a match, the database 508 notifies the first computing device 504 of the identity of the component 708¹, 708².

In one embodiment, the verification module 512 inspects the flow of execution of the component 708¹, 708². For example, where the component 708¹, 708² is a source code file or an object code file, the verification module 512 may inspect the code, or subsets thereof, and generate representations of the order in which discrete sections of the code (e.g., routines, sub-routines, functions, loops, etc.) are found and/or will be executed. The generated representations may then be transmitted to the database 508 for comparison against a collection of known source code or object code flow of execution representations. When the comparison yields a match, the database 508 notifies the first computing device 504 of the identity of the component 708¹, 708²

In one embodiment, the verification module 512 inspects copyright notices in the component 708¹, 708². For example, where the component 708¹, 708² is a source code file or an object code file, the verification module 512 may inspect the file and reproduce all copyright notices identified therein. The verification module 512 may identify such copyright notices by, for example, searching the file in a non-case-sensitive manner for the text string “copyright,” searching the file in a non-case-sensitive manner for the text string “all rights reserved,” searching the file in a non-case-sensitive manner for the text string “(c),” or searching the file for the symbol “©.” The reproduced copyright notices may then be transmitted to the database 508 for comparison against a collection of known copyright notices. When the comparison yields a match, the database 508 notifies the first computing device 504 of the identity of the component 708¹, 708². In some instances, however, the verification module 512 may be able to determine the identity of the component 708¹, 708² from the copyright notices identified therein and, as such, need not involve the database 508.

In one embodiment, rather than being configured to search the source code or object code for all instances of a copyright notice, the verification module 512 may be configured to search the source code or object code for specific copyright notices. In such an embodiment, the database 508 need not be involved. For example, the verification module 512 may simply wish to confirm the identity of a specific component 708¹, 708² without involving the database 508. If, for example, the verification module 512 suspects, from a review of the license(s) and/or other information that it received together with the protectable content prior to step 604, that the component 708¹, 708² is the XYZ Corporation's 2005 software code, the verification module 512 may search the source code or object code of the component 708¹, 708² for non-case-sensitive text strings such as “XYZ Corporation,” “Copyright **** by XYZ Corporation,” or “© **** by XYZ Corporation.” In such a case, when the verification module 512 finds a match for one or more of those text strings in the component 708¹, 708², it may confirm that the component 708¹, 708² is the XYZ Corporation's 2005 software code. In one embodiment, to make such a confirmation, the verification module 512 requires that another supporting match be made by another one of the techniques described herein.

In one embodiment, the verification module 512 may inspect license information, which may be incomplete, in the component 708¹, 708². For example, where the component 708¹, 708² is a source code file or an object code file, the verification module 512 may inspect the file to identify all instances where license information appears. The verification module 512 may then reproduce certain license information from the identified instances, such as, for example, identifications of the licenses themselves and/or the types of the licenses, the scopes of the licenses, the durations of the licenses, the payments to be made under the licenses, or combinations thereof. The reproduced license information may, for example, be transmitted to the database 508 for comparison against a collection of known license information. When the comparison yields a match, the database 508 notifies the first computing device 504 of the identity of the component 708¹, 708². In some instances, however, the verification module 512 may be able to determine the identity of the component 708¹, 708² from the identified license information and, as such, need not involve the database 508.

In one embodiment, the verification module 512 may inspect license text, which may be incomplete, in the component 708¹, 708². For example, where the component 708¹, 708² is a source code file or an object code file, the verification module 512 may inspect the file to identify all instances where license text appears. The verification module 512 may then reproduce all or certain portions of the license text from the identified instances. The reproduced license text may then be transmitted to the database 508 for comparison against a collection of known license text. When the comparison yields a match, the database 508 notifies the first computing device 504 of the identity of the component 708¹, 708². In some instances, however, the verification module 512 may be able to determine the identity of the component 708¹, 708² from the identified license text and, as such, need not involve the database 508.

In one embodiment, rather than being configured to search the source code or object code for all instances of license information or license text, the verification module 512 may be configured to search the source code or object code for specific license information or license text. In such an embodiment, the database 508 need not be involved. For example, the verification module 512 may simply wish to confirm the identity of a specific component 708¹, 708² without involving the database 508. If, for example, the verification module 512 suspects, from a review of the license(s) and/or other information that it received together with the protectable content prior to step 604, that the component 708¹, 708² is the XYZ Corporation's software code, the verification module 512 may search the source code or object code of the component 708¹, 708² for specific license information or license text found in the appropriate software license of the XYZ Corporation. In such a case, when the verification module 512 finds a match for the specific license information or license text in the component 708¹, 708², it may confirm that the component 708¹, 708² is the XYZ Corporation's software code. In one embodiment, to make such a confirmation, the verification module 512 requires that another supporting match be made by another one of the techniques described herein.

In one embodiment, the verification module 512 inspects the component 708¹, 708² for specific text strings. For example, where the component 708¹, 708² is a source code file, the verification module 512 may inspect the file to identify the presence or absence of certain text strings, such as, for example, “Microsoft,” “Eclipse,” “Oracle,” and “fsf.org.” Where the component 708¹, 708² is an object code file, the verification module 512 may employ a hexadecimal translator to inspect the file and identify the presence or absence of certain text strings in constants. Having identified certain specific text strings, the verification module 512 may then, for example, reproduce the text strings and transmit them to the database 508 for comparison against a collection of known text strings. When the comparison yields a match, the database 508 notifies the first computing device 504 of the identity of the component 708¹, 708².

In one embodiment, the verification module 512 filters its identification of specific text strings in the component 708¹, 708² and may also filter its query to the database 508. For example, where the component 708¹, 708² is a source code file, the verification module 512 may filter or restrict its identification of specific text strings to those which occur only in the comments or, alternatively, to those which occur only in the code. Moreover, the verification module 512 may filter or restrict its identification of specific text strings to those text strings that occur only in string constants or to those that occur only in the lowercase, and may treat all white-spaces, no matter how long, as equal. The query to the database 508 for a specific text string match may also be filtered as such.

In one embodiment, rather than inspecting the component 708¹, 708² for specific text strings, the verification module 512 reproduces larger sections of text from the component 708¹, 708², for example from the source code of the component 708¹, 708², and transmits the reproduced sections of text to the database 508 for comparison against a collection of known text sections. When the comparison yields a match, the database 508 notifies the first computing device 504 of the identity of the component 708¹, 708².

In one embodiment, where the component 708¹, 708² is an object code file, the verification module 512 inspects the object code file to identify its symbol tables. Having identified the object code file's symbol tables, the verification module 512 may then reproduce the symbol tables themselves, or, alternatively, only its symbols, and transmit them to the database 508 for comparison against a collection of known symbol tables or symbols. When the comparison yields a match, the database 508 notifies the first computing device 504 of the identity of the component 708¹, 708².

In one embodiment, the component 708¹, 708² is verified using a profile of information previously generated about a component. The profile can include information about the component, the operation of the component, the licensing of the component, and so on. The profile can include a signature on one or more components, such that the component 708¹, 708² can be verified by matching the signature in the component. In one embodiment, the profile is a certificate that includes information about the protected content, the components of the protected content, and the licenses associated with the components.

If the signatures do not match, for example if there have been modifications to the component since the time of the last signature, the component can be verified, for example, by identifying a previous version of the component that signatures do match, identifying the modifications, and then performing one or more of the above steps on the identified modifications, or as another example, by manually inspecting the modifications and any available information about the modifications (e.g., a change log) to determine whether the modifications affect the licensing status.

Once the verification module 512 has determined, using one or more of the techniques described above, the identity of the component 708¹, 708² (e.g., what it is), the verification module 512 proceeds at step 608 or at step 612, as appropriate, to identify the license for the component 708¹, 708². Most simply, the license can be verified through use of a profile, as described herein, that includes, for example, information about the component 708¹, 708² and/or any license terms applicable to the component 708¹, 708². In one embodiment, the stored profile is stored in a database 508 and is retrieved therefrom after the identity of the component 708¹, 708² is determined. In one embodiment, the profile includes a digital signature of the component. In one embodiment, the profile includes a digital signature on the profile, such the origin of the profile can be cryptographically verified.

In another embodiment, the profile includes other information about components instead of or in addition to or in combination with the information above. For example, the profile can include (without limitation) one or more of the following items: The name of the component, an identifier for the component, a table of contents describing the components, the date of the creation of the profile or of the verification, the number of files covered by the verification, the date of the oldest file reviewed, the date of the most recent file reviewed, the scope of the verification (e.g., verification of source code files, import statements, include files, copyright notices, executable code, etc.), the number of components used, an identification of each of the components that are included in the verified code, a list of the components, a hierarchy (e.g., in XML or other format) that shows which components are included in which other components, an indication of the degree of integration of the subcomponent (e.g., dynamically linked library, independent application, statically linked code, etc.), the amount of code reviewed in kilobytes, the number of files reviewed, a degree of confidence in the results, and/or the number of different licenses covering the code. Again, this is exemplary; some or all of the above may be included along with other relevant information.

Referring to Table 1, an exemplary profile can provided in any suitable manner. As shown in Table 1, the profile is implemented in a self-describing computer language. The example of Table 1 is used to show how various exemplary types of information may included in a profile, and not to limit or restrict the information or types of information that can be included. The example profile of Table 1 includes the name of the component, and an identifier for the component. The example includes the date of the earliest (i.e., first) file, and the date of the most recent file. The profile includes information about the scope of the verification that was conducted on the component, which as shown a source code verification. The profile includes the number of files associated with the component. The profile includes a list of components that are included with the component, in this example, called Example2 and Example3. Example3 is shown to have 3 components: Example4, Example5, and Example6. The profile also includes a list of the 10 files that are included in this component: file 1.c, file2.c, etc. In some implementations the files can be listed in the description of the component, such that each file is associated with a component. The files covered by a profile may include any sort of files, such as source code files, object code files, libraries, and executables. Thus, the profile can include or be used to generate a “table of contents,” or list of elements, for the component, describing each of the elements of the component and their licensing terms. In one embodiment, the list of elements in the profile is hierarchical, such that it is clear that which components are part of other components.

As mentioned, the profile may include a license for a component. The profile may include a license for each component within a component. In this example, a license is listed for each component Example1-Example6. The license can be specified by name, as shown, or in other implementations can be specified by a numerical or other identifier. The license(s) can be specified within the component listing, but could also be provided in a separate list, or other manner. The profile in Table 1 includes a signature on the contents of the profile. The signature can be used to verify the integrity of the profile. In some implementations, the signature would be accompanied by an identifier describing the entity that generated the signature. In some implementations, the profile also includes a signature on the components and/or on the files, for confirming their integrity.

TABLE 1
EXEMPLARY PROFILE

<profile>
<name> Example1 </name>
<id> 99A98CD82A22 </id>
<license>GPL<license>
<first-file-date> 01/10/1996 </first-file-date>
<last-file-date> 05/05/2004 </last-file-date>
<scope> source code < scope>
< file-count> 10 </file-count>
<component ><name> Example2 </name><id>1AF3293B0106
</id><license>Apache</license></component >
<component >
< name> Example3 </ name> <id>6475293A1224
</id><license>GPL</license>

<component><name> Example4 </name> <id>3174657782AC
</id><license>GPL</license></component>
<component> <name> Example5 </name> <id>7654AB54CA45
</id><license>LGPL</license></component>
<component> <name> Example6 </name> <id> 8473E0F11100
</id><license><LGPL></license></component>

</component>
<files>file1.c file2.c file3.cpp. file4.h file5.prl file6.php file7.jar
file8.dll file9.o file10</files>
<signature> 3F4D2D29FF318394 </signature>
</profile>

Although not shown, the profile also can include information about the licenses, for example, terms and characteristics about the license.

The verification module 512 also can determine at step 608 or at step 612, as appropriate, stated license information for the component 708¹, 708². In one embodiment, this information is determined from the license(s) and/or other information that was received together with the protectable content prior to step 604. One or more of the techniques described above can be used to identify the stated license information. The stated information may include the information that the entity who developed or transmitted the protectable content, the license(s), and/or the other information to the first computing device 504 states is applicable to the component 708¹, 708². The stated information may include, for example, the purported origin of the component 708¹, 708² and/or purported license terms for the component 708¹, 708². The profile may be generated by an entity other than the generator of the content.

In one embodiment, to verify, at step 608 or at step 612, as appropriate, the license for the component 708¹, 708², the verification module 512 compares the stated information against a stored profile. If the stated information matches the stored profile, the license received by the first computing device 504 for the component 708¹, 708² is verified to be valid. Otherwise, if the stated information does not match the stored profile, the license received by the first computing device 504 for the component 708¹, 708² is invalid (i.e., it does not, or does not alone, govern the use and/or distribution of the component 708¹, 708²).

Once the received licenses for the first and second components 708¹, 708² are verified to be valid at steps 608 and 612, the verification module 512 proceeds to verify, at step 616, the license that it received from the transmitting entity for the protectable content 704¹. The verification of the received license for the protectable content 704¹ is based at least in part on the verification of the license for the first component 708¹ and the verification of the license for the second component 708². For example, in one embodiment, the verification module 512 employs the verified license for the first component 708¹ and the verified license for the second component 708² to construct an aggregated license for the protectable content 704¹. More specifically, as described above with respect to FIGS. 1 and 2, the verification module 512 can employ a license evaluation software process 134 to form license profiles 114 representing the verified licenses for the first and second components 708¹, 708², and can also employ a license aggregation software process 136 to analyze the attributes and attribute values of such license profiles and thereby determine specific attribute and attribute value compatibilities and/or incompatibilities. The specific attribute and attribute value compatibilities and/or incompatibilities may then be used by the verification module 512 to construct the aggregated license for the protectable content 704¹.

Once the aggregated license for the protectable content 704¹ is constructed, the verification module 512 may compare that aggregated license against the received license that purportedly governs the protectable content 704¹ (i.e., the license for the protectable content 704¹ originally received by the first computing device 504 prior to step 604). If the constructed aggregated license for the protectable content 704¹ matches the received license for the protectable content 704¹, the received license for the protectable content 704¹ is verified to be valid. Otherwise, if the constructed aggregated license for the protectable content 704¹ does not match the received license for the protectable content 704¹, the received license for the protectable content 704¹ is invalid (i.e., it does not govern the use and/or distribution of the protectable content 704¹).

In one embodiment, the constructed aggregated license for the protectable content 704¹ and the received license for the protectable content 704¹ are each found to include the verified license for the first component 708¹ and the verified license for the second component 708². It may be, however, that the component licenses are incompatible, and this can be recognized as well. For example, the license for one component may require certain notices that are forbidden by the other license. In such case the verification can fail.

In another embodiment, the constructed aggregated license for the protectable content 704¹ and the received license for the protectable content 704¹ are each found to include the union of the most restrictive aspects of the verified license for the first component 708¹ and the most restrictive aspects of the verified license for the second component 708². In such exemplary cases, the constructed aggregated license for the protectable content 704¹ is found to match or be compatible with the received license for the protectable content 704¹ and the received license for the protectable content 704¹ is verified to be valid. It should be understood that the constructed aggregated license for the protectable content 704¹ can also be found to match the received license for the protectable content 704¹ in other ways.

The comparison of the constructed aggregated license for the protectable content 704¹ and the received license for the protectable content 704¹ may be performed in any number of ways. For example, in one non-limiting example, the verification module 512 employs the license evaluation software process 134 to form license profiles 114 for the constructed aggregated license and the received license. Those profiles 114 for each license may then be compared to determine if they match. Other methods for comparing the constructed aggregated license and the received license, as known to those skilled in the art, may also be employed.

With reference again to the exemplary hierarchical structure for the protectable content 700 depicted in FIG. 7 and to the method 600 depicted in FIG. 6, step 608 or step 612 of the method 600 may again be performed, as described above, for each bottom-level component 712¹ to 712ⁿ to verify the received licenses therefor, and may also again be performed to verify the received license for the second-level component 704³. In addition, step 616 of the method 600 may again be performed, as described above, to verify the received license for the second-level protectable content 704². In addition still, if the received licenses for components 704¹. 704², and 704³ are all verified to be valid, the received license for top-level protectable content 700 may also be verified by again performing step 616 of the method 600.

Referring still to FIG. 6, after the received license for the protectable content 700 and the received licenses for its components 704¹. 704², and 704³ are verified to be valid, the digital signature module 520 may digitally sign, at step 620, the protectable content 700. In such an embodiment, the digital signature indicates that the received license for the protectable content 700 in fact governs the use and/or distribution of the protectable content 700.

Alternatively, in another embodiment, the received licenses for the components 704¹, 704², and 704³ are all verified to be valid, but the received license for protectable content 700 is not found to match the constructed aggregated license for protectable content 700 when compared thereto. In such an embodiment, the received license for the protectable content 700 is invalid (i.e., does not govern the use and/or distribution of the protectable content 700). Nevertheless, in such a case, the digital signature module 520 may still digitally sign the protectable content 700. In this case, however, the digital signature indicates that the constructed aggregated license for the protectable content 700 in fact governs the use and/or distribution of the protectable content 700. In such an embodiment, the constructed aggregated license for the protectable content 700 may in the future be transmitted with the digitally signed protectable content 700.

Following step 620, where the received license for the protectable content 700 is verified to be valid, the first computing device 504 may comfortably use the protectable content 700 as set forth by the terms of that received license. In addition, if permitted by the terms of the received license for the protectable content 700, the first computing device 504 may distribute the protectable content 700 together with all received licenses. The first computing device 504 may also generate and distribute a certificate that includes the digital signature for the protectable content 700 and that certifies that the licenses it is distributing in fact govern the use and/or distribution of the protectable content 700.

Where the protectable content 700 is computer code, such a certificate may include a checksum for the computer code as the digital signature for the computer code. Advantageously, in such a case, entities receiving the computer code from the first computing device 504 in the future may verify that the computer code is in fact governed by the licenses distributed by the first computing device 504 by computing themselves a checksum for the computer code and comparing it to the checksum contained within the certificate. If the checksums match, such entities are assured that the computer code has not been modified and that its use and/or distribution is still governed by the licenses received from the first computing device 504. If, however, the checksums do not match, the computer code has been modified and the licenses received from the first computing device 504 may or may not still govern the use and/or distribution of the computer code. In this latter case, the computer code and the licenses may be re-submitted to the first computing device 504, or submitted to another device, for verification as described above with reference to the method 600.

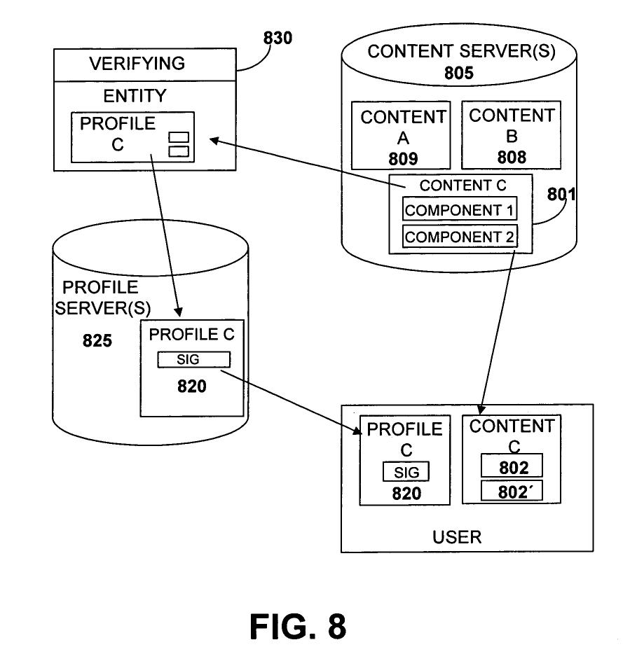

Referring to FIG. 8, as an illustrative example, an exemplary protectable content C 801 can be found on content servers 805. The protectable content C 801 can be an sort of content, in this example it is a software product that is available for download over the Internet with its source code. The protectable content C 801 has components 802a, 802b that make up the content 801. The content servers 805 can be one or one of many servers on which this content 801 and other content 808, 809 are available. The servers can be a web site or other content site, for example such as the sites found at http://sourceforge.net, http://www.apache.org, etc. A user 815 downloads the protectable content C from the Internet, and wishes to verify the license, or content list, or table of contents for the component. The user 815 obtains a profile C 820 from a profile server 825. The profile server 825 can be the same server as the content server 805, the same type of server as the content server 805, or the profile server 825 can be a different server or a different type of server. The user 815 identifies the profile C 820 that is associated with the content C 801. The user can then use the profile 820 to such items as the components of content C, the licenses of the components of the content C, and ultimately the content C and the license for content C. As additional examples, the user can verify the name of one or more components, an identifier for the component, the date of the creation of the profile or of the verification, the number of files covered by the verification, the date of the oldest file reviewed, the date of the most recent file reviewed, the activities employed during the verification (e.g., source code files, import statements, include files, copyright notices), the number of components used, an identification of each of the components that are included in the verified code, a reference to a profile describing protectable content, a list of the components, a hierarchy (e.g., in XML or other format) that shows which components are included in which other components, an indication of the degree of integration of the subcomponent (e.g., dynamically linked library, independent application, statically linked code, etc.), the amount of code reviewed in kilobytes, the number of files reviewed, a degree of confidence in the results, the number of different licenses covering the code.

The profile C 820 could be generated in real time, but typically is generated earlier by a verifying entity 830. The verifying entity obtains the content C 801, performs the steps described above, and generates a profile for the content C 801. The profile is then stored on the profile server 825, or can be stored with the content C 801 on the content server (and can even be included with the distribution of the content C 801). As described, the profile C 820 can include one or more signatures on the components or the entire content generated by the entity 830, such that the user 815 can easily determine the licensing for the content. If the user 815 trusts the entity 830, the user will feel confident in the information in the profile.

Thus, in one embodiment, a verification entity identifies content, verifies the content, and generates profiles on the content, which profiles can be used to later to again verify content.

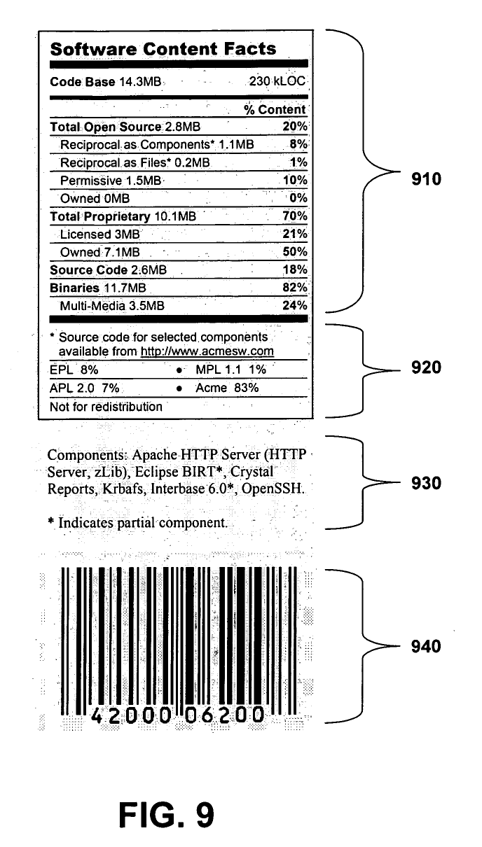

Referring to FIG. 9, an exemplary content facts report 900 describing software content is shown. The exemplary report 900 provides facts regarding the software content. Just as a label found on a container of food shows the ingredients, the exemplary report 900 describes the ingredients of protectable content. As shown, the report 910 includes the size of code (in megabytes and lines of code), the amount of open source found in the content and the amount of proprietary code found in the content. Amounts can be shown in size (e.g., bytes, lines of code), and/or percentages. For the open source code, the report includes the amount of the code that has a particular license type. In this example, “reciprocal” type open source licenses, and the amount of code that has “permissive” type open source licenses. The report includes the amount of content owned by the content owner. The report also includes the amount of code identified as “proprietary” code, for example, code that is not “open source,” and of this proprietary code, how much has been licensed and how much is owned. The report also indicates the amount of the package that is source code and the amount that is binaries, and of the binaries, the amount that are multimedia files.

The report also indicates 920 that the source code for particular components are available from a particular internet web site (as may be required by the reciprocal licenses). It should be understood that this may include multiple web sites, or none, as applicable. The report also includes the amount of code covered by certain licenses, here, certain reciprocal licenses and proprietary licenses. The licenses may be selected for inclusion on the list by including all readily-identifiable licenses, by the largest percentages covered, or by selecting licenses that are most likely to be interesting to a reader of the report (i.e., licenses that have certain restrictions). The report also includes use or distribution restrictions that cover the content. For example, the report indicates that the content is “Not for Redistribution.”

The report also specifies 930 components that are included in the content. The components in this example include separately identifiable components, including Apache HTTP Server, Eclipse BIRT, Crystal Reports, Krbafs, Interbase 6.0, and OpenSSH. There is also an indication that two of the reports (Eclipse BIRT and Interbase 6.0) are partial components, meaning that they have not been included in their entirety. Again, this information provides more information to the reader about what is included in the content.

The report also specifies 940 an identifier for the content. Although shown in the form of a bar code that can be scanned with an optical reader, the identifier need not be in bar code form. The identifier can be an identifier that identifies the content, but by associating the content with a specific identifier, the reader of the report can understand that an entity as reviewed this particular content, and identify its ingredients. By confirming that the content is the content associated with the identifier, a user of content can feel confident that it has been verified. The identifier, then becomes an indicator of confidence in the component.

While shown in form of a written description, the report can, as described above, be stored in the form of a profile in a self-describing language, and also include such checksums and signatures to allow verification of the content and the profile information. The profile may include such information as can be used to produce a report as exemplified in the figure. The exemplary similarity in form to a food package “label” demonstrates a technique for users to quickly and easily understand the important elements of content obtained from third parties so that they can use the content appropriately and with confidence.

In general, it should be noted that the present invention may be provided as one or more computer-readable programs embodied on or in one or more articles of manufacture. The article of manufacture may be a floppy disk, a hard disk, a CD ROM, a flash memory card, a PROM, a RAM, a ROM, or a magnetic tape. In general, the computer-readable programs may be implemented in any programming language. Some examples of languages that can be used include C, C++, or JAVA. The software programs may be stored on or in one or more articles of manufacture as object code.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for verifying protectable content, the method comprising:
verifying a license for a first component of the protectable content;
verifying a license for a second component of the protectable content; and
verifying a license for the protectable content based at least in part on the verification of the license for the first component and the verification of the license for the second component.

2. The method of claim 1, wherein the verification of the license for the first component comprises determining the identity of the first component, determining stated information for the first component, and comparing the stated information against a stored profile associated with the identity of the first component.

3. The method of claim 2, wherein the stated information comprises a stated origin of the first component, and the stored profile identifies an origin of the first component.

4. The method of claim 2, wherein the stated information comprises license terms for the first component, and the stored profile comprises license terms for the first component.

5. The method of claim 4, wherein the profile comprises a list of the elements of the protectable content.

6. The method of claim 5, wherein the list is hierarchical.

7. The method of claim 5, wherein the list includes the elements of the first component and the second component.

8. The method of claim 1, wherein the verification of the license for the second component comprises determining the identity of the second component, determining stated information for the second component, and comparing the stated information against a stored profile associated with the identity of the second component.

9. The method of claim 8, wherein the stated information comprises an origin of the second component, and the stored profile comprises an origin of the second component.

10. The method of claim 8, wherein the stated information comprises license terms for the second component, and the stored profile comprises license terms for the second component.

11. The method of claim 1 further comprising decomposing the protectable content into the first and second components.

12. The method of claim 1 further comprising digitally signing the protectable content after the license for the first component is verified to be valid and the license for the second component is verified to be valid.

13. The method of claim 1 further comprising digitally signing the protectable content after the license for the first component is verified to be valid, the license for the second component is verified to be valid, and the license for the protectable content is verified to be valid.

14. The method of claim 1, wherein the license for the protectable content comprises the license for the first component and the license for the second component.

15. The method of claim 1, wherein the license for the protectable content comprises the union of the most restrictive aspects of the license for the first component and the most restrictive aspects of the license for the second component.

16. The method of claim 1, wherein the protectable content comprises one or more of a source code file, an object code file, a multimedia presentation, a video segment, an audio segment, a textual representation, a work of art, a visual representation, a technological know-how, a business know-how, and a contract right.

17. A method for verifying protectable content, the method comprising:
receiving a profile for the protectable content, the profile comprising a list of the components of the protectable content;
verifying a license for a first of the components of the protectable content using information in the profile;
verifying a license for a second of the components of the protectable content using information in the profile; and
verifying a license for the protectable content based at least in part on the verification of the license for the first component and the verification of the license for the second component.

18. The method of claim 15, wherein the profile comprises references to profiles for the components of the protectable content.

19. A method for verifying protectable content, the method comprising:
verifying a first component of the protectable content;
verifying a second component of the protectable content; and
verifying the protectable content based at least in part on the verification of the first component and the second component.

20. The method of claim 19, wherein the verification of the components comprises determining the identity of each component, determining stated information for each component, and comparing the stated information against a stored profile associated with the identity of each component.

21. The method of claim 20, wherein the stated information for each of the components comprises a stated origin of such component, and the stored profile identifies an origin of such component.

22. The method of claim 20, wherein the stated information comprises license terms for the component, and the stored profile comprises license terms for the component.

23. The method of claim 22, wherein the stored profile comprises a list of the elements of the protectable content.

24. The method of claim 23, wherein the list is hierarchical.

25. The method of claim 23, wherein the list comprises elements of the first component and the second component.

26. The method of claim 25, wherein the components each comprise computer source code.

27. The method of claim 19 further comprising digitally signing the first component after the first component is verified and digitally signing the second component after the second component is verified.

28. The method of claim 19 further comprising digitally signing the entire protectable content after the first component is verified, the second component is verified, and the protectable content is verified.

29. The method of claim 19 further comprising verifying the digital signature of the protectable content after the first component is verified and the second component is verified.

30. The method of claim 19 further comprising verifying the digital signature of the protectable content by verifying a digital signature on a first component and verifying a digital signature on second component of the protectable content.

31. A computer readable medium comprising a data structure for use in verifying protectable content, the protectable content comprising computer source code, the data structure comprising a hierarchical list of elements of protectable content, the list comprising for each component of the protectable content an identification of such component of the protectable content, a list of the elements of such component of protectable content, stated information for such component of protectable content, and a digital signature of the component of the protectable content.

32. The data structure of claim 1, wherein the stated information comprises license terms for the component.
